(19) United States
(12) Patent Application Publication
(10) Pub. No.: US 2025/0218390 A1
(43) Pub. Date: Jul. 3, 2025

(54) GATE DRIVER AND DISPLAY DEVICE INCLUDING THE SAME

(71) Applicant: LG Display Co., Ltd., Seoul (KR)

(72) Inventors: Ju Hong KIM, Paju-si (KR); Byeong Seong SO, Paju-si (KR)

(21) Appl. No.: 18/918,697

(22) Filed: Oct. 17, 2024

(30) Foreign Application Priority Data
Dec. 29, 2023 (KR) 10-2023-0197819

(51) Int. Cl. G09G 3/3266; G09G 3/3233

(52) U.S. Cl. CPC G09G 3/3266; G09G 3/3233; G09G 2300/0819; G09G 2300/0852; G09G 2310/0286; G09G 2310/06; G09G 2310/08; G09G 2320/0238; G09G 2320/0242; G09G 2320/043; G09G 2320/0673; G09G 2320/0693; G09G 2330/023; G09G 2354/00

(57) ABSTRACT

The present specification discloses a gate driver including first and second pull-up transistors, first and second pull-down transistors, a first output terminal configured to output a carry signal, an A^{th} transistor disposed between the first and second pull-up transistors and configured to electrically separate a Q node in response to a control signal, a B^{th} transistor disposed between the A^{th} and second pull-up transistors and configured to supply a low potential voltage to the second pull-up transistor in response to a control bar signal, and a C^{th} transistor connected to the second output terminal to supply the low potential voltage in response to the control bar signal. According to the present specification, by reducing a capacitive load compared to the related art at the same time upon sensing for electrical characteristic compensation of a pixel circuit, it is possible to quickly charge a capacitance and enable accurate sensing.

### CROSS-REFERENCE TO RELATED APPLICATION

This application claims priority to and the benefit of Korean Patent Application No. 10-2023-0197819, filed on Dec. 29, 2023, the disclosure of which is incorporated herein by reference in its entirety.

### BACKGROUND

### Technical Field

The present specification relates to a gate driver and a display device including the same.

### Description of the Related Art

Electroluminescence display devices may be classified into inorganic light emitting display devices and organic light emitting display devices according to a material of a light emitting layer. Display matrix type organic light emitting diode display devices include organic light emitting diodes (hereinafter referred to as “OLEDs”) that emit light by itself and have advantages of a quick response time, high luminous efficiency and luminance, and a wide viewing angle. Each of the OLED display devices includes OLEDs formed in each pixel. Since the OLED display devices have a quick response time, excellent luminous efficiency and luminance, and wide viewing angles and may express a black grayscale in perfect black, the OLED display devices have an excellent contrast ratio and color gamut.

Driving elements should have uniform electrical characteristics in all pixels, but there may be differences in electrical characteristics between pixels due to process deviation and differences in device characteristics, and differences in electrical characteristics between the driving elements may increase as a driving time of the display device elapses.

### BRIEF SUMMARY

A gate driver according to the present specification may include a plurality of signal transmission units configured to receive a clock signal and sequentially output gate signals and cascade-connected to each other,
at least one of the plurality of signal transmission units includes a first pull-up transistor turned on based on a potential of a Q node, a second pull-up transistor turned on based on the potential of the Q node, a first pull-down transistor turned on based on a potential of a Qb node, a second pull-down transistor turned on based on the potential of the Qb node, and an A^{th} transistor disposed between the first pull-up transistor and the second pull-up transistor and configured to electrically separate the Q node in response to a control signal.

A gate driver according to the present specification includes an n^{th} signal transmission unit and an (n+1)^{th} signal transmission unit configured to receive a clock signal and sequentially output gate signals and cascade-connected to each other (n is a positive integer of 1 or more), wherein each of the n^{th} signal transmission unit and the (n+1)^{th} signal transmission unit may include a first pull-up transistor turned on based on a potential of a Q node, a second pull-up transistor turned on based on the potential of the Q node, a first pull-down transistor turned on based on a potential of a Qb node, a second pull-down transistor turned on based on the potential of the Qb node, a first output terminal configured to output a carry signal according to operations of the first pull-up transistor and the first pull-down transistor, a second output terminal configured to output the gate signal according to operations of the second pull-up transistor and the second pull-down transistor, an A^{th} transistor disposed between the first pull-up transistor and the second pull-up transistor and configured to electrically separate the Q node in response to a control signal, a B^{th} transistor disposed between the A^{th} transistor and the second pull-up transistor and configured to supply a second low potential voltage to the second pull-up transistor in response to a control bar signal, and a C^{th} transistor connected to the second output terminal to supply a first low potential voltage in response to the control bar signal.

A display device according to the present specification may include a gate driver including an n^{th} signal transmission unit and an (n+1)^{th} signal transmission unit that are cascade-connected to each other (n is a positive integer of 1 or more), an n^{th} pixel line set including an n^{th} odd-numbered pixel line that receives an n^{th} gate signal output from the n^{th} signal transmission unit and an n^{th} even-numbered pixel line that receives the n^{th} gate signal output from the n^{th} signal transmission unit, and an (n+1)^{th} pixel line set including an (n+1)^{th} odd-numbered pixel line that receives an (n+1)^{th} gate signal output from the (n+1)^{th} signal transmission unit and an (n+1)^{th} even-numbered pixel line that receives the (n+1)^{th} gate signal output from the (n+1)^{th} signal transmission unit, and for a sensing time for external compensation, when the n^{th} gate signal is a gate-on voltage, the (n+1)^{th} gate signal is a gate-off voltage, and when the (n+1)^{th} gate signal is the gate-on voltage, the n^{th} gate signal is the gate-off voltage.

### BRIEF DESCRIPTION OF THE SEVERAL VIEWS OF THE DRAWINGS

FIG. 1A is a block diagram showing a display device according to an embodiment of the present specification.

FIG. 1B is a block diagram showing a display device according to another embodiment of the present specification.

FIG. 2 is a cross-sectional view showing a cross-sectional structure of a display panel shown in FIG. 1A.

FIG. 3 is a view showing a time when the display device enters a sensing mode in a driving sequence of the display device.

FIG. 4 is a circuit diagram schematically showing a pixel circuit and a sensing circuit according to the present specification.

FIG. 5 is a waveform diagram schematically showing a signal applied to the pixel circuit shown in FIG. 4.

FIG. 6 is a circuit diagram showing the pixel circuit according to one embodiment of the present specification.

FIG. 7 is a waveform diagram showing a method of driving the pixel circuit according to one embodiment of the present specification.

FIGS. 8A to 8D are circuit diagrams showing operating states of the pixel circuit corresponding to each operation of FIG. 7.

FIG. 9 is a waveform diagram showing a method of driving a pixel circuit according to another embodiment of the present specification.

FIG. 10 is a circuit diagram showing a current flowing in the pixel circuit shown in FIG. 6 in a second initialization operation.

FIG. 11A is a view showing one embodiment in which an output signal of a gate driver and pixels are shared in the present specification.

FIG. 11B is a view showing another embodiment in which the output signal of the gate driver and the pixels are shared in the present specification.

FIG. 12 is a view schematically showing a shift register of the gate driver.

FIG. 13 is a circuit diagram showing the pixel circuit according to one embodiment of the present specification.

FIG. 14 is a waveform diagram showing voltage levels of signals input to switch elements shown in FIG. 13 during a sensing time for external compensation of the display device.

FIG. 15 is a circuit diagram showing an operating state of the pixel circuit during the sensing time for external compensation of the display device.

FIG. 16 is a view schematically showing the shift register of the gate driver according to one embodiment of the present specification.

FIG. 17 is a circuit diagram specifically showing a signal transmission unit included in the gate driver according to one embodiment of the present specification.

FIG. 18 is a waveform diagram showing input/output waveforms during a display time in the gate driver according to one embodiment of the present specification.

FIG. 19 is a view showing operating states of the signal transmission unit corresponding to DA to DC sections of FIG. 18.

FIGS. 20A to 20F are circuit diagrams showing the operating states of the signal transmission unit corresponding to the DA section to the DC section of FIG. 18.

FIG. 21 is a waveform diagram showing input/output waveforms during the sensing time for external compensation in the gate driver according to one embodiment of the present specification.

FIG. 22 is a view showing operating states of the signal transmission unit corresponding to SA to SC sections of FIG. 21.

FIGS. 23A to 23F are circuit diagrams showing the operating states of the signal transmission unit corresponding to the SA section to the SC section of FIG. 21.

FIG. 24 is a waveform diagram showing voltage levels of signals input to switch elements shown in FIG. 13 during the sensing time for external compensation of the display device according to one embodiment of the present specification.

FIG. 25 is a circuit diagram showing operating states of pixel circuits during the sensing time for external compensation of the display device according to one embodiment of the present specification.

### DETAILED DESCRIPTION

Technical improvements and features of the present specification and methods for achieving them will become clear with reference to embodiments described below in detail in conjunction with the accompanying drawings. The present disclosure is not limited to the embodiments disclosed below but can be implemented in various different forms, these embodiments are merely provided to make the disclosure of the present disclosure complete and fully inform those skilled in the art to which the present disclosure pertains of the scope of the present disclosure.

In describing the present disclosure, when it is determined that the detailed description of a related known technology may unnecessarily obscure the gist of the present disclosure, detailed description thereof will be omitted.

When the terms “comprise,” “include,” “have,” and “consist of” described in the present specification are used, other parts may be added unless “only” is used. When a component is expressed in the singular, it can be construed as a plurality of components unless specifically stated otherwise.

When the position relationship and interconnection relationship between two components, such as “on,” “above,” “under,” “next to,” “connected or coupled,” “crossing or intersecting,” or the like described, one or more other components may be interposed between the components unless the term “immediately” or “directly” is described.

When the temporal relationship is described using the term “after,” “subsequently,” “then,” “before,” or the like, it may include a non-consecutive case unless the term “immediately” or “directly” is used.

Although the term “first,” “second,” or the like may be used to distinguish components, functions or structures of the components are not limited by the ordinal number or component name added to the front of the component.

The following embodiments may be partially or fully coupled or combined, and various technological interworking and driving are possible. The embodiments may be implemented independently of each other and implemented together in the associated relationship.

In addition, terms (including technical and scientific terms) used in embodiments of the present specification may be construed as meaning that may be generally understood by those skilled in the art to which the present specification pertains unless explicitly specifically defined and described, and the meanings of the commonly used terms, such as terms defined in a dictionary, may be construed in consideration of contextual meanings of related technologies.

In a display device according to the present specification, a pixel circuit and a gate driving circuit may include a plurality of transistors. The transistor may be an oxide thin film transistor (TFT) containing an oxide semiconductor or a low temperature poly silicon (LTPS) TFT containing an LTPS.

The transistor is a three-electrode element including a gate, a source, and a drain. The source is an electrode for supplying carriers to the transistor. The carriers start to flow from the source in the transistor. The drain is an electrode through which the carriers move from the transistor to the outside. In the transistor, the carriers flow from the source to the drain.

In the case of an n-channel transistor, since the carriers are electrons, a source voltage is lower than a drain voltage so that the electrons may flow from the source to the drain. In the n-channel transistor, a current flows from the drain to the source. In the case of a p-channel transistor, since the carriers are holes, the source voltage is higher than the drain voltage so that the holes may flow from the source to the drain. In the p-channel transistor, a current flows from the source to the drain because the holes flow from the source to the drain. It should be noted that the source and drain of the transistor are not fixed. For example, the source and the drain may be changed depending on an applied voltage. Therefore, the disclosure is not limited by the source and drain of the transistor. In the following description, the source and drain of the transistor are referred to as “first and second electrodes.”

A gate signal may swing between a gate-on voltage and a gate-off voltage. The transistor is turned on in response to the gate-on voltage, whereas the transistor is turned off in response to the gate-off voltage. In the case of the n-channel transistor, the gate-on voltage may be a gate high voltage (VGH), and the gate-off voltage may be a gate low voltage (VGL). In the case of the p-channel transistor, the gate-on voltage may be the gate low voltage (VGL), and the gate-off voltage may be the gate high voltage (VGH).

Hereinafter, embodiments of the present disclosure will be described in detail with reference to the accompanying drawings.

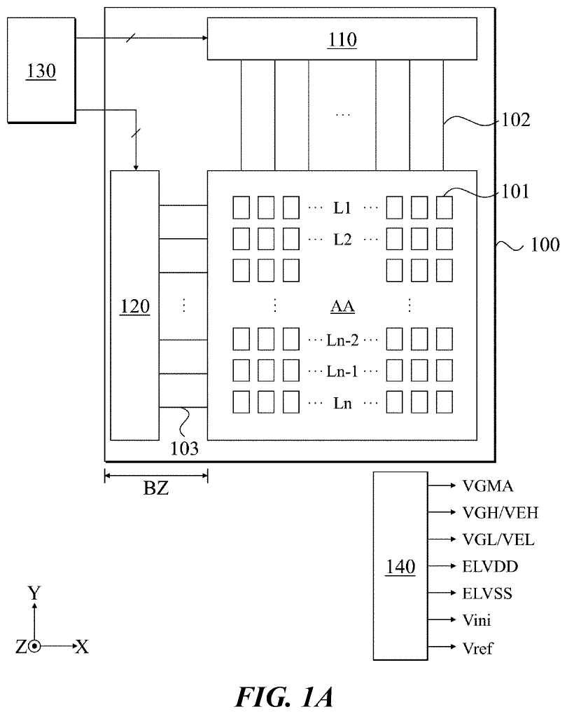

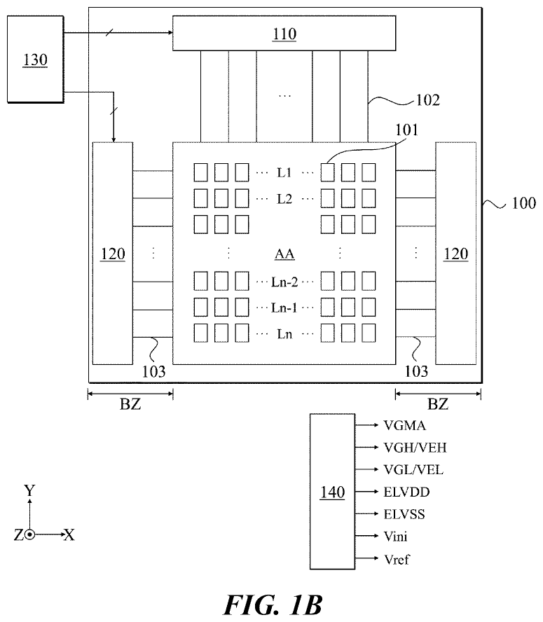

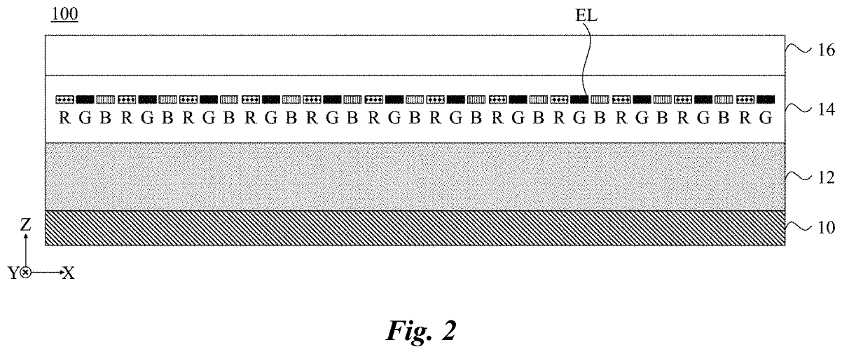

FIG. 1A is a block diagram showing a display device according to an embodiment of the present specification. FIG. 1B is a block diagram showing a display device according to another embodiment of the present specification. FIG. 2 is a cross-sectional view showing a cross-sectional structure of a display panel shown in FIG. 1.

Referring to FIGS. 1A, 1B, and 2, the display device may include a display panel 100, a display panel driving unit for writing pixel data on pixels of the display panel 100, and a power supply unit 140 for generating power required for driving the pixels and the display panel driving unit.

The display panel 100 may be a panel having a rectangular structure having a length in an X-axis direction, a width in a Y-axis direction, and a thickness in a Z-axis direction. The display panel 100 may include a pixel array in which an input image is displayed on a screen. The pixel array may include a plurality of data lines 102, a plurality of gate lines 103 that intersect the data lines 102, and pixels disposed in a matrix form. The display panel 100 may further include power lines commonly connected to the pixels. The power lines may supply a constant voltage required for driving the pixels 101 to the pixels 101. For example, the display panel 100 may include a VDD line to which a pixel driving voltage ELVDD is applied and a VSS line to which a low potential power voltage ELVSS is applied. In addition, the power lines may further include a REF line to which a reference voltage Vref is applied and an INIT line to which an initialization voltage Vinit is applied.

A cross-sectional structure of the display panel 100 may include a circuit layer 12, a light emitting element layer 14, and an encapsulation layer 16 that are stacked on a substrate 10 as shown in FIG. 2.

The circuit layer 12 may include a TFT array including a pixel circuit connected to lines such as a data line, a gate line, and a power line, a gate driver 120, etc. The lines and circuit elements of the circuit layer 12 may include a plurality of insulating layers, two or more metal layers with an insulating layer interposed therebetween, and a display layer containing a semiconductor material. All transistors formed on the circuit layer 12 may be implemented as n-channel oxide TFTs.

The light emitting element layer 14 may include a light emitting element EL driven by the pixel circuit. The light emitting element EL may include a red (R) light emitting element, a green (G) light emitting element, and a blue (B) light emitting element. The light emitting element layer 14 may include a white light emitting element and a color filter. The light emitting elements EL of the light emitting element layer 14 may be covered with a protective layer including an organic film and a protective film.

The encapsulation layer 16 may cover the light emitting element layer 14 to seal the circuit layer 12 and the light emitting element layer 14. The encapsulation layer 16 may have a multi-insulating film structure formed by alternately stacking an organic film and an inorganic film. The inorganic film can block permeation of moisture or oxygen. The organic film may planarize a surface of the inorganic film. When the organic film and the inorganic film are stacked in multiple layers, a movement path of moisture or oxygen may be longer than that of a single layer, thereby effectively blocking the permeation of moisture and oxygen affecting the light emitting element layer 14.

A touch sensor layer (omitted from the drawing) may be formed on the encapsulation layer 16, and a polarizer or a color filter layer may be disposed on the touch sensor layer. The touch sensor layer may include capacitive type touch sensors for sensing touch input based on a change in capacitance before and after touch input. The touch sensor layer may include metal lines patterns and insulating films that generate the capacitance of the touch sensors. The insulating films may insulate intersections of the metal line patterns and planarize a surface of the touch sensor layer. The polarizer can increase visibility and contrast ratio by converting the polarization of external light reflected by the metal of the touch sensor layer and the circuit layer. The polarizer may be implemented as a polarizer or circular polarizer in which a linear polarizer and a phase retardation film are bonded. A cover glass may be bonded onto the polarizer. The color filter layer may include red, green, and blue color filters. The color filter layer may further include a black matrix pattern. The color filter layer may absorb a portion of a wavelength of light reflected from the circuit layer and the touch sensor layer to serve as a polarizer and increase the color purity of the image displayed in the pixel array.

The pixel array may include a plurality of pixel lines L1 to Ln. Each of the pixel lines L1 to Ln may include pixels of one line disposed in a line direction (X-axis direction) in the pixel array of the display panel 100. Pixels disposed in one pixel line may share the gate lines 103. Sub-pixels disposed in a column direction Y in the data line direction may share the same data line 102. One horizontal period (1H) is the time obtained by dividing one frame period by the total number of pixel lines L1 to Ln. The pixel lines L1 to Ln may be classified into an odd-numbered pixel line PXLO and an even-numbered pixel line PXLE.

The display panel 100 may be implemented as a non-transmissive display panel or a transmissive display panel. The transmissive display panel may be applied to a transparent display apparatus in which images are displayed on a screen and a real object in the background is visible. The display panel 100 may be manufactured as a flexible display panel.

Each of the pixels 101 may be divided into a red sub-pixel, a green sub-pixel, and a blue sub-pixel to implement colors. Each of the pixels may further include a white sub-pixel. Each sub-pixel may include a pixel circuit. Hereinafter, “pixel” may be construed as the same meaning as “sub-pixel.” Each pixel circuit may be connected to the data lines, the gate lines, and the power lines.

The pixels may be disposed as real color pixels and pentile pixels. The pentile pixel may implement a higher resolution than the real color pixel by driving two sub-pixels of different colors as one pixel 101 using a preset pixel rendering algorithm. The pixel rendering algorithm may compensate insufficient color expression in each pixel with colors of light emitted from adjacent pixels.

The power supply unit 140 may generate a DC voltage (or a constant voltage) required for driving the pixel array of the display panel 100 and the display panel driving unit using a DC-DC converter. The DC-DC converter may include a charge pump, a regulator, a buck converter, a boost converter, etc. The power supply unit 140 may generate DC voltages (or constant voltages) such as a gamma reference voltage VGMA, gate-on voltages VGH/VEH, gate-off voltages VGL/VEL, a pixel driving voltage ELVDD, a low potential power voltage ELVSS, an initialization voltage Vinit, and a reference voltage Vref by adjusting a level of a DC input voltage applied from a host system (not shown). The gamma reference voltage VGMA may be supplied to a data driver 110. The gate-on voltages VGH/VEH and the gate-off voltage VGL/VEL may be applied to the gate driver 120. The constant voltages such as the pixel driving voltage ELVDD, the low potential power voltage ELVSS, the initialization voltage Vinit, and the reference voltage Vref may be supplied to the pixels 101 through the power lines commonly connected to the pixels 101. The constant voltages applied to the pixel circuit may have different voltage levels.

The display panel driving unit may write pixel data of the input image on the pixels of the display panel 100 under the control of a timing controller 130.

The display panel driving unit may include the data driver 110 and the gate driver 120.

The display panel driving unit may further include a touch sensor driver for driving touch sensors. The touch sensor driver is omitted from FIGS. 1A and 1B. The data driver 110 and the touch sensor driver may be integrated into one drive IC. In a mobile device or wearable device, the timing controller 130, the power supply unit 140, the data driver 110, etc., may be integrated into one drive IC.

The data driver 110 may receive the pixel data of the input image received as a digital signal from the timing controller 130 and output a data voltage. The data driver 110 may convert the pixel data of the input image into a gamma compensation voltage every frame period using a digital to analog converter (DAC) and output a data voltage Vdata. The gamma reference voltage VGMA may be divided into the gamma compensation voltage for each grayscale through a voltage dividing circuit. The gamma compensation voltage for each grayscale may be provided to the DAC of the data driver 110. The data voltage Vdata may be output from each of channels of the data driver 110 through an output buffer.

The gate driver 120 may be implemented as a gate in panel (GIP) circuit formed on the circuit layer 12 disposed on the display panel 100 together with a TFT array of the pixel array and lines. The gate driver 120 may be disposed on a bezel area BZ, which is a non-display area of the display panel 100, or at least some of the gate driver 120 may be disposed by being distributed in the pixel array in which the input image is displayed. The gate driver 120 may sequentially output gate signals to the gate lines 103 under the control of the timing controller 130. The gate driver 120 may sequentially supply the gate signals to the gate lines 103 by shifting the gate signals using a shift register. The gate signal may include various gate pulses such as a scan pulse and an emission control pulse (hereinafter referred to as “EM pulse”).

The gate driver 120 may be disposed at any one side of left or right non-display area BZ outside the display area on the display panel 100 to supply the gate signals to the gate lines 103 in a single feeding method. In the single feeding method, the gate signal may be applied at one end of the gate line 103.

Referring to FIG. 1B, the gate driver 120 may be disposed in the left non-display area BZ and the right non-display area BZ of the display panel 100 to apply the gate signals to the gate lines 103 in a double feeding method. In the double feeding method, the gate signal may be applied simultaneously at both ends of the gate line 103.

The timing controller 130 may receive digital video data DATA of the input image and a timing signal synchronized with the digital video data from the host system. The timing signal may include a vertical synchronization signal Vsync, a horizontal synchronization signal Hsync, a data enable signal DE, etc. Since the vertical period and horizontal period can be known in a method of counting the data enable signal DE, the vertical synchronization signal Vsync and the horizontal synchronization signal Hsync can be omitted. The data enable signal DE may have a period of 1 horizontal period (1H).

The host system may be any one of a TV system, a tablet computer, a notebook PC, a navigation system, a personal computer (PC), a home theater system, a mobile device, a wearable device, and a vehicle system. The host system may scale the image signal from the video source according to the resolution of the display panel 100 and transmit the scaled image signal to the timing controller 130 together with the timing signal.

The timing controller 130 may control the operation timing of the display panel driving unit at a frame frequency of an input frame frequency×i Hz by multiplying the input frame frequency by i in a normal driving mode (i is a natural number). The input frame frequency is 60 Hz in a national television standards committee (NTSC) type and 50 Hz in a phase-alternating line (PAL) type.

The timing controller 130 may provide a data timing control signal for controlling the operation timing of the data driver 110 based on the timing signals Vsync, Hsync, and DE received from the host system and a gate timing control signal for controlling the operation timing of the gate driver 120. The timing controller 130 may synchronize the data driver 110, the touch sensor driver, and the gate driver 120 by controlling the operation timing of the display panel driving unit.

The gate timing control signal generated from the timing controller 130 may be input to the shift register of the gate driver 120 through a level shifter. The level shifter may receive the gate timing control signal, generate a start pulse and a shift clock that swing between the gate high voltage and the gate low voltage, and provide the start pulse and the shift clock to the shift register of the gate driver 120.

A display mode (or a display time) in which the pixel data of the input image is written on the pixels may be classified into a normal driving mode and a low-speed driving mode. In the low-speed driving mode, the consumed power of the display panel 100 and the display panel driving circuit can be reduced, and thus the display device may be driven with low power. The low-speed driving mode may be set to reduce the consumed power of the display device when the input image is not changed as much as a preset number of frames by analyzing the input image. The low-speed driving mode can reduce the consumed power of the display panel driving circuit and the display panel 100 by reducing a frame frequency at which the pixel data is written on the pixels, that is, a refresh rate, when a still image is input for a predetermined time or longer. The low-speed drive mode is not limited to when the still image is input. For example, when the display device operates in a standby mode or when a user command or an input image is not input to the display panel driving circuit for a predetermined time or longer, the display panel driving circuit may operate in the low-speed driving mode.

The timing controller 130 may reduce the refresh frame frequency at which the pixel data is written on the pixels in the low-speed driving mode compared to the normal driving mode. For example, in the normal driving mode, the refresh frame frequency at which the pixel data is written on the pixels may be any one of a frequency of 60 Hz or higher, such as 60 Hz, 120 Hz, 144 Hz, and 240 Hz, and the refresh frame frequency in the low-speed driving mode may be lower than that of the normal driving mode. The timing controller 130 may reduce the driving frequency of the display panel driving circuit and the pixels by setting a plurality of hold frames after a refresh frame to reduce the refresh rate of the pixels in the low-speed driving mode. In the refresh frame, the pixel data of the input image may be written on the pixels. In the hold frame, sub-pixels may be maintained at the data voltage stored in a capacitor from the previous refresh frame.

The display panel driving circuit may scan the pixels in the display mode under the control of the timing controller 130 and write the pixel data of the input image on the pixels 101. In the display mode, the input image may be displayed on a display area AA. The sensing circuit may sense the threshold voltage of a driving element DT from all sub-pixels by sequentially sensing the sub-pixels of the display area AA on a line basis in the sensing mode.

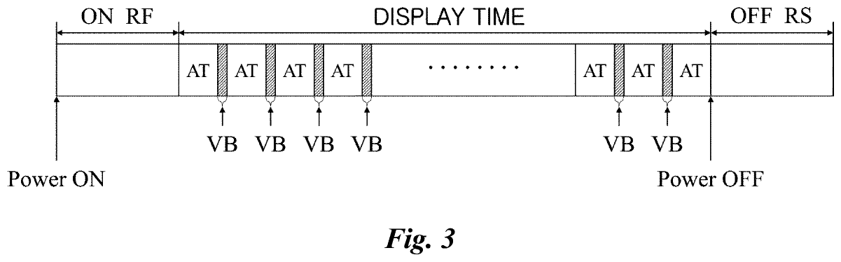

FIG. 3 is a view showing a time when the display device enters a sensing mode in a driving sequence of the display device.

Referring to FIG. 3, the display device may enter the sensing mode in at least one of a power-on sequence in which power starts to be applied to the display device, a vertical blank time VB within the display time, and a power-off sequence in which a turn-off switch of the display device is turned on. The vertical blank time VB is a blank time excluding an active time AT during which the pixel data of the input image is written on the pixels within one frame period. During the vertical blank time VB, the pixel data may not be input to the data driver, and the pixel data may not be written on the sub-pixels. During the active time AT, the pixel data DATA may be input to the data driver, and the data voltage output from the data driver may be charged to the sub-pixels so that the pixel data may be written on the sub-pixels.

In the power-off sequence, the sensing circuit may be further driven for a predetermined time after the power-off switch is turned on to sense the threshold voltage of the driving element in each sub-pixel. Then, the sensing circuit may stop operating when power is cut off. During the sensing time, sensing data output from sensing channels of the data driver may be transmitted to the timing controller.

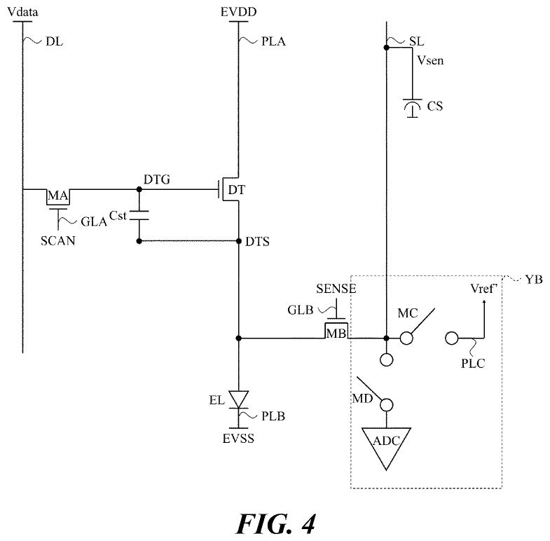

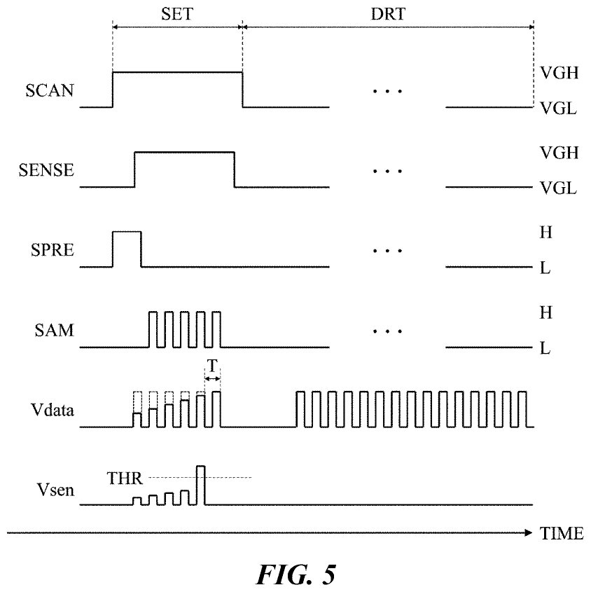

FIG. 4 is a circuit diagram schematically showing a pixel circuit and a sensing circuit according to the present specification. FIG. 5 is a waveform diagram schematically showing a signal applied to the pixel circuit shown in FIG. 4. The pixel circuit according to the present specification is not limited to FIG. 4.

Referring to FIGS. 4 and 5, the pixel circuit may include a light emitting element EL, a driving element DT, a capacitor Cst, A^{th} and B^{th} switch elements MA and MB, etc. The sensing circuit may include an analog-digital converter ADC and an external compensation circuit unit YB including C^{th} and D^{th} switch elements MC and MD. The driving element DT and the switch elements MA to MD may be implemented as n-channel transistors, but are not limited thereto. The ADC and switch elements MC and MD of the sensing circuit may be disposed in the sensing channel of the data driver.

The pixel circuit may be connected to constant voltage nodes such as an A^{th} constant voltage node PLA to which the pixel driving voltage EVDD is applied, a B^{th} constant voltage node PLB to which the low potential power voltage EVSS is applied, a C^{th} constant voltage node PLC to which a reference voltage Vref′, etc. The constant voltage nodes PLA, PLB, and PLC may be connected to the power lines commonly connected to the pixels. The pixel driving voltage EVDD may be set to a voltage at which the driving element DT operates in a saturation region. The pixel driving voltage EVDD may be higher than the highest voltage (or a white grayscale voltage) of the data voltage Vdata. The low potential power voltage EVSS and the reference voltage Vref may be lower than the pixel driving voltage EVDD and lower than the lowest voltage (or a black grayscale voltage) of the data voltage Vdata.

The pixel circuit may be connected to a data line DL to which the data voltage Vdata is applied, an A^{th} gate line GLA to which an A^{th} gate signal SCAN is applied, a B^{th} gate line GLB to which a B^{th} gate signal SENSE is applied, and a sensing line SL.

During a sensing time SET, the data driver may output a pulse whose voltage gradually increases under the control of the timing controller. The timing controller may transmit the pulse whose data value increases regardless of the pixel data of the input image to the data driver during the sensing time SET. The data driver may convert data received from the timing controller into the data voltage Vdata through a digital-analog converter (DAC) of a data channel.

During the sensing time SET, pulses of the data voltage Vdata may be applied to an A^{th} node DTG in a state in which the A^{th} and B^{th} switch elements MA and MB have been turned on. In this case, a gate-source voltage (Vgs) of the driving element DT is a difference between a gate voltage of the data voltage Vdata applied to the A^{th} node DTG and a voltage at a B^{th} node DTS, that is, a sensing voltage Vsen. When the pulse voltage of the data voltage Vdata is applied to the A^{th} node DTG to turn the driving element DT on, the threshold voltage (Vth) of the driving element DT may be sensed as the sensing voltage Vsen that quickly increases.

During a display time DRT, the data channels of the data driver may convert the pixel data of the input image received from the timing controller into the data voltage Vdata and output the data voltage Vdata.

The gate driver may control the A^{th} and B^{th} switch elements MA and MB by outputting the first and second gate signals SCAN and SENSE under the control of the timing controller for the sensing time SET. The control circuit in the timing controller or the data driver may control the switch elements MC and MD of the sensing circuit by generating C and D gate signals SPRE and SAM for controlling the C^{th} and D^{th} switch elements MC and MD. The C and D gate signals SPRE and SAM may include pulses that swing between a high voltage H and a low voltage L of a digital signal voltage level.

The A^{th} gate signal SCAN may include a pulse maintained at the gate high voltage VGH for a preset time, for example, 20 horizontal periods for the sensing time SET. The A^{th} switch element MA may be turned on in response to the gate high voltage VGH of the A^{th} gate signal SCAN and turned off when the voltage of the A^{th} gate signal SCAN is the gate low voltage VGL.

The B^{th} gate signal SENSE may include the pulse of the gate high voltage VGH generated for the sensing time SET. The B^{th} switch element MB may be turned on in response to the gate high voltage VGH of the B^{th} gate signal SENSE. After the A^{th} switch element MA is turned on, the B^{th} switch element MB may be turned on and turned off when the voltage of the B^{th} gate signal SENSE is the gate low voltage VGL. For the sensing time SET, the voltage of the B^{th} gate signal SENSE may increase to the gate high voltage VGH after the voltage of the A^{th} gate signal SCAN is inverted to the gate high voltage VGH. For the sensing time SET, the voltage of the B^{th} gate signal SENSE may be reduced to the gate low voltage VGL and then the voltage of the A^{th} gate signal SCAN may be reduced to the gate low voltage VGL.

The C^{th} gate signal SPRE may include the pulse of the high voltage H generated for the sensing time SET. The C^{th} switch element MC may be turned on in response to the high voltage H of the C^{th} gate signal SPRE and turned off when a voltage of the C^{th} gate signal SPRE is the low voltage L. The C^{th} switch element MC may be turned on earlier than the B switch element MB. The voltage of the C^{th} gate signal SPRE may increase to the high voltage H when the voltage of the A^{th} gate signal SCAN is changed to the gate high voltage VGH and decrease to the low voltage L when the voltage of the B^{th} gate signal SENSE is changed to the gate high voltage VGH.

The D^{th} gate signal SAM may include the pulse of the high voltage H generated for the sensing time SET. The D^{th} switch element MD may be turned on in response to the high voltage H of the D^{th} gate signal SAM and turned off when the voltage of the D^{th} gate signal SAM is the low voltage L. The D^{th} gate signal SAM may be the high voltage H whenever the pulse of the data voltage Vdata is applied to the A^{th} node DTG to transmit the sensing voltage Vsen on the sensing line SL to the ADC. The pulse of the D^{th} gate signal SAM may be repeatedly generated while the voltages of the first and second gate signals SCAN and SENSE are maintained at the gate high voltage VGH, that is, while the A^{th} and B^{th} switch elements MA and MB maintains the ON state. The pulses of the D^{th} gate signal SAM and the pulse of the data voltage Vdata may alternate. Therefore, the D^{th} switch element MD may be turned on whenever the pulse of the data voltage Vdata is applied to the A^{th} node DTG of the pixel circuit.

For the sensing time SET, the data voltage Vdata applied to the data line DL may include a plurality of pulses whose voltage gradually increases. A pulse period T of the data voltage Vdata may be 2 horizontal periods, but is not limited thereto. In one embodiment, the threshold voltage (Vth) of the driving element DT may be sensed while the voltage level of the data voltage Vdata is changed. Therefore, the sensing time SET can be significantly reduced compared to the sensing method using the conventional source follower circuit. In addition, it is possible to reduce the consumed power of the display device, increase a resolution of the display device, and enable high-speed sensing even when a driving speed increases.

The driving element DT may drive the light emitting element EL by supplying a current to the light emitting element EL according to the gate-source voltage (Vgs). A difference in voltage between the A^{th} node DTG and the B^{th} node DTS may be the gate-source voltage (Vgs) of the driving element DT. The driving element DT may include a first electrode connected to the A^{th} constant voltage node PLA to which the pixel driving voltage EVDD is applied, a gate electrode connected to the A^{th} node DTG, and a second electrode connected to the B^{th} node DTS. The capacitor Cst may be connected between the A^{th} node DTG and the B^{th} node DTS.

The light emitting element EL may be implemented as an OLED. The light emitting element EL may include an anode, a cathode, and an organic compound layer formed between the electrodes. The anode of the light emitting element EL may be connected to the B^{th} node DTS, and the cathode may be connected to the B^{th} constant voltage node PLB to which the low potential power voltage EVSS is applied. The organic compound layer may include a hole injection layer (HIL), a hole transport layer (HTL), a light emission layer (EML), an electron transport layer (ETL), and an electron injection layer (EIL), but is not limited thereto. When a voltage is applied to the anode and the cathode of the light emitting element EL, holes passing through the hole transport layer (HTL) and electrons passing through the electron transport layer (ETL) move to the light emission layer (EML) to generate excitons. At this time, visible light may be emitted from the light emitting layer (EML). The light emitting element EL may be implemented in a tandem structure in which a plurality of light emitting layers are stacked. The light emitting element EL having the tandem structure can increase the luminance and lifetime of the pixel.

The A^{th} switch element MA may be connected between the data line DL and the A^{th} node DTG and turned on in response to the gate high voltage VGH of the A^{th} gate signal SCAN. When the A^{th} switch element MA is turned on, the data voltage Vdata may be applied to the A^{th} node DTG. The A^{th} switch element MA may include a first electrode connected to the data line DL, a gate electrode connected to the A^{th} gate line GLA to which the A^{th} gate signal SCAN is applied, and a second electrode connected to the A^{th} node DTG.

The B^{th} switch element MB may be connected between the B^{th} node DTS and the sensing line SL and turned on in response to the gate high voltage VGH of the B^{th} gate signal SENSE. When the B^{th} switch element MB is turned on, the B^{th} node DTS may be electrically connected to the sensing line SL. The B^{th} switch element MB may include a first electrode connected to the B^{th} node DTS, a gate electrode connected to the B^{th} gate line GLB to which the B^{th} gate signal SENSE is applied, and a second electrode connected to the sensing line SL.

A capacitor CS in which the sensing voltage Vsen is stored may be connected to the sensing line SL. The capacitor CS may be a parasitic capacitance connected to the sensing line SL. The capacitor CS may be a separate capacitor connected to the sensing line SL.

The C^{th} switch element MC may be connected between the sensing line SL and the C^{th} constant voltage node PLC to which the reference voltage Vref is applied and turned on in response to the high voltage H of the C^{th} gate signal SPRE. When the C^{th} switch element MC is turned on, the reference voltage Vref may be applied to the sensing line SL so that the sensing line SL may be initialized to the reference voltage Vref. The C^{th} switch element MC may include a first electrode connected to the sensing line SL, a gate electrode to which the C^{th} gate signal SPRE is applied, and a second electrode connected to the C^{th} constant voltage node PLC.

The D^{th} switch element MD may be connected between the sensing line SL and the ADC and turned on in response to the high voltage H of the D^{th} gate signal SAM. When the D^{th} switch device MD is turned on, the voltage Vsen sensed at the B^{th} node DTS of the pixel circuit may be input to the ADC through the sensing line SL and the D^{th} switch element MD.

While the A^{th} and B^{th} switch elements MA and MB maintain the ON states, the pulse of the third gate signal SAM may be the high voltage H. Since the D^{th} switch element MD is turned on every pulse of the third gate signal SAM, the sensing voltage Vsen changed according to the pulse voltage of the data voltage Vdata may be input to the ADC every pulse of the third gate signal SAM.

The ADC may convert the sensing voltage Vsen into digital data and output sensing data Dsen. The D^{th} switch element MD may include a first electrode connected to the sensing line SL, a gate electrode to which the D^{th} gate signal SAM is applied, and a second electrode connected to an ADC input terminal. Meanwhile, a sample & hold circuit, an amplifier, an integrator, etc., may be added between the D^{th} switch element MD and the ADC.

For the sensing time SET, when the gate-source voltage (Vgs) of the driving element DT is greater than the threshold voltage of the driving element DT as the voltage of the data voltage Vdata applied to the A^{th} node DTG is gradually increased by a plurality of pulses, the driving element DT may be turned on to quickly increase the drain-source current of the driving element DT. When the driving element DT is turned on, the voltage at the B^{th} node DTS quickly increases, and thus the sensing voltage Vsen input to the ADC may also increase quickly.

The timing controller may determine that the sensing voltage Vsen indicated by the sensing data Dsen received from the ADC is the threshold voltage (Vth) of the driving element DT when the value of the sensing data Dsen is greater than the threshold THR by comparing the sensing data Dsen received from the sensing channel of the data driver with a preset threshold THR and derive a compensation value for compensating a shift amount of the threshold voltage of the driving element DT. The threshold voltage (Vth) corresponding to the sensing voltage Vsen and the compensation value for compensating the shift amount of the threshold voltage (Vth) may be stored in advance in a look-up table memory accessed by the timing controller. Threshold voltage data stored in the look-up table memory may be stored for each sub-pixel. When the sensing data Dsen is input, the look-up table memory may output a compensation value of the threshold voltage (Vth) stored at an address indicated by the sensing data Dsen. The timing controller may update the threshold voltage data stored in the look-up table memory with the sensing data Dsen received from the ADC.

The timing controller may modulate the pixel data DATA by adding or multiplying the compensation value derived according to the sensing data Dsen to or by the pixel data DATA of the input image. The modulated pixel data DATA may have a grayscale value modulated by the shift amount of the threshold voltage of the driving element DT. Pixel data DATA′ modulated by the timing controller may be transmitted to the data driver for the display time DRT and written on the sub-pixels. The data driver may convert the pixel data DATA′ received from the timing controller for the display time DRT into the data voltage Vdata and output the data voltage Vdata.

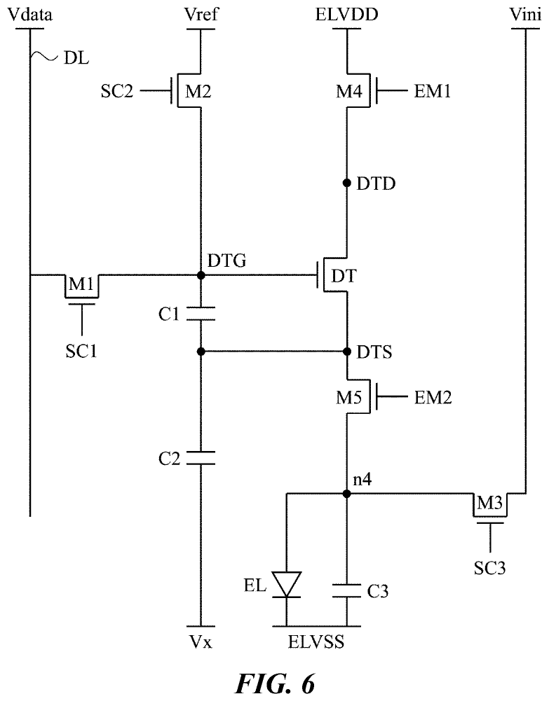

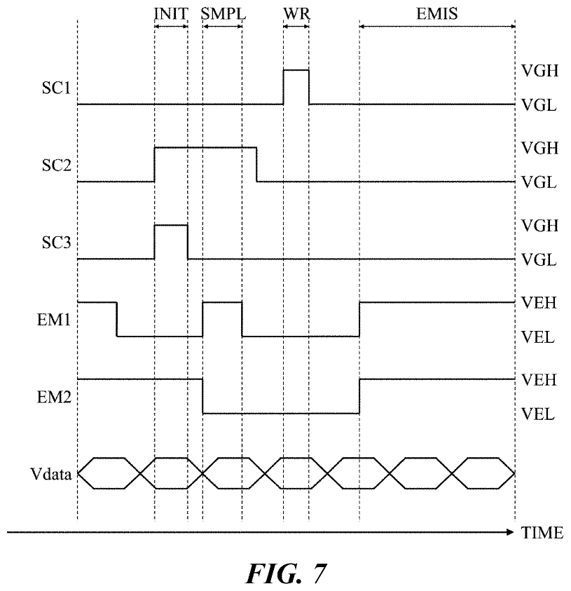

FIG. 6 is a circuit diagram showing the pixel circuit according to one embodiment of the present specification. FIG. 7 is a waveform diagram showing a method of driving the pixel circuit according to one embodiment of the present specification.

Referring to FIGS. 6 and 7, the pixel circuit may include the light emitting element EL, the driving element DT for supplying a current to the light emitting element EL, a plurality of switch elements M1 to M5, a first capacitor C1, and a second capacitor C2. The following description will be made assuming that the driving element DT and the switch elements M1 to M5 in the pixel circuit are implemented as n-channel oxide TFTs, but the present specification is not limited thereto.

The gate signal may include a first scan pulse SC1 (or a first gate pulse), a second scan pulse SC2 (or a second gate pulse), a third scan pulse SC3 (or a third gate pulse), a first EM pulse EM1 (or a fourth gate pulse), and a second EM pulse EM2 (or a fifth gate pulse). To drive the shown pixel circuit, the gate driver may include a first shift register for sequentially outputting the first scan pulse SC1, a second shift register for sequentially outputting the second scan pulse SC2, a third shift register for sequentially outputting the third scan pulse SC3, a fourth shift register for sequentially outputting the first EM pulse EM1, and a fifth shift register for sequentially outputting the second EM pulse EM2.

The constant voltage, such as the pixel driving voltage ELVDD, the low potential power voltage ELVSS, the reference voltage Vref, and the initialization voltage Vini, may be applied to the pixel circuit. The pixel driving voltage ELVDD may be higher than the low potential power voltage ELVSS. The gate-on voltages VGH/VEH may be set to be higher than the pixel driving voltage ELVDD. The gate-off voltages VGL/VEL may be set to be lower than the low potential power voltage ELVSS. The initialization voltage Vini may be set to a low potential voltage higher than the low potential voltage ELVSS. The reference voltage Vref may be set to a voltage at which the driving element DT may be turned on. The reference voltage Vref may be set to a voltage within the voltage range of the data voltage Vdata output from the data driver 110. The highest voltage of the data voltage Vdata may be lower than the pixel driving voltage ELVDD, and the smallest voltage of the data voltage Vdata may be higher than the low potential power voltage ELVSS.

In a sampling stage SMPL, to sample the threshold voltage (Vth) of the driving element DT, the reference voltage Vref is in some implementations set to a voltage higher than the initialization voltage Vini. A voltage difference between the reference voltage Vref and the initialization voltage Vini may be set to a voltage higher than the threshold voltage (Vth) of the driving element DT. The initialization voltage Vini should be set to a voltage lower than the threshold voltage of the light emitting element EL to implement the lowest luminance of the pixel, that is, the luminance of a black grayscale.

As shown in FIG. 7, the display time of the pixel circuit may include an initialization stage INIT, the sampling stage SMPL set after the initialization stage INIT, an addressing stage WR set after the sampling stage SMPL, and an emission stage EMIS set after the addressing stage WR.

The first scan pulse SC1 may be the gate-on voltage VGH in the addressing stage WR in synchronization with the data voltage Vdata of the pixel data. The first scan pulse SC1 may be the gate-off voltage VGL in the initialization stage INIT, the sampling stage SMPL, and the emission stage EMIS.

The second scan pulse SC2 may be the gate-on voltage VGH in the initialization stage INIT and the sampling stage SMPL. The second scan pulse SC2 may be the gate-off voltage VGL in the addressing stage WR and the emission stage EMIS.

The third scan pulse SC3 may be the gate-on voltage VGH in the initialization stage INIT. The third scan pulse SC3 may be the gate-off voltage VGL in the sampling stage SMPL, the addressing stage WR, and the emission stage EMIS.

The first EM pulse EM1 may be the gate-off voltage VEL in the initialization stage INIT and the addressing stage WR. The first EM pulse EM1 may be the gate-on voltage VEH in the sampling stage SMPL and the emission stage EMIS.

The second scan pulse EM2 may be the gate-on voltage VEH in the initialization stage INIT and the emission stage EMIS. The second EM pulse EM2 may be the gate-off voltage VEL in the sampling stage SMPL and the addressing stage WR.

Each of the switch elements M1 to M5 may be turned on when the gate-on voltages VGH/VEH are applied to a gate electrode and turned off when the gate-off voltages VGL and VEL are applied to the gate electrode. The driving element DT may be turned on when the gate-source voltage (Vgs) is higher than the threshold voltage (Vth) to generate a current according to the gate-source voltage (Vgs) and may drive the light emitting element EL.

The light emitting element EL may be implemented as the OLED. The OLED may include the organic compound layer formed between the anode and the cathode. The organic compound layer may include the hole injection layer (HIL), the hole transport layer (HTL), the emission layer (EML), the electron transport layer (ETL), and the electron injection layer (EIL), but is not limited thereto. The anode of the light emitting element EL may be connected to a fourth node n4, and the cathode thereof may be connected to a VSS node to which the low potential driving voltage ELVSS is applied. The VSS node may be connected to the VSS line. The light emitting element EL may include a third capacitor C3 formed between the anode and the cathode.

When a voltage is applied to the anode and the cathode of the light emitting element EL, holes passing through the hole transport layer (HTL) and electrons passing through the electron transport layer (ETL) may move to the light emission layer EML to generate excitons. At this time, visible light may be emitted from the light emitting layer (EML).

The driving element DT may include the gate electrode connected to a first node DTG, the first electrode connected to a second node DTS, and the second electrode connected to a third node DTD. The voltage applied to each electrode of the driving element DT may be substantially the same as the voltages at the first to third nodes DTG, DTS, and DTD.

The first capacitor C1 may be connected between the first node DTG and the second node DTS. The first capacitor C1 may store the gate-source voltage (Vgs) of the driving element DT. The second capacitor C2 may be connected between the second node DTS and a Vx node. A constant voltage, for example, a constant voltage of any one of the pixel driving voltage ELVDD, the low potential power voltage ELVSS, the reference voltage Vref, and the initialization voltage Vini may be applied to the Vx node. The Vx node may be connected to the VDD line to which a relatively stable constant voltage such as the pixel driving voltage ELVDD is applied.

The first capacitor C1 and the second capacitor C2 may determine a transmission rate of the data voltage Vdata at the gate-source voltage (Vgs) of the driving element DT according to their capacity ratios. Capacities of the first capacitor C1 and the second capacitor C2 may be appropriately selected according to the voltage range of the data voltage Vdata and the driving characteristics of the display panel.

In the shown pixel circuit, the gate-source voltage (Vgs) of the driving element DT may be Vgs=(1−C′)×(Vdata−Vref)+Vth in the emission stage EMIS. Here, C′=C1/(C1+C2). When C2=0, C′=1, and in the above equation, (1−C′) becomes zero, resulting in Vgs=Vth. Therefore, the second capacitor C2 may be needed to change the gate-source voltage (Vgs) of the driving element DT according to the data voltage Vdata of the pixel data.

The first switch element M1 may be turned on according to the gate-on voltage VGH of the first scan pulse SC1 to supply the data voltage Vdata to the first node DTG in the addressing stage WR. The first switch element M1 may include a gate electrode connected to the first gate line to which the first scan pulse SC1 is applied, a first electrode connected to the data line DL to which the data voltage Vdata is applied, and a second electrode connected to the first node DTG.

The second switch element M2 may be turned on according to the gate-on voltage VGH of the second scan pulse SC2 to supply the reference voltage Vref to the first node DTG in the initialization stage INIT and the sampling stage SMPL. The second switch element M2 may include a gate electrode connected to the second gate line to which the second scan pulse SC2 is applied, a first electrode connected to the REF line to which the reference voltage Vref is applied, and a second electrode connected to the first node DTG.

When the data voltage Vdata and the reference voltage Vref are applied to the pixel circuit through the data line DL, the number of transitions applied to the data line DL may increase. When the data voltage Vdata and the reference voltage Vref are applied to the pixel circuit through the data line DL, the frequency of the data line DL may increase, thereby increasing the consumed power of the display device. In the display device according to one embodiment of the present specification, the data line DL to which the data voltage Vdata is applied and the REF line to which the reference voltage Vref is applied may be separated. Therefore, the frequency of the voltage applied to the data line DL can be reduced, thereby reducing consumed power.

The third switch element M3 may be turned on according to the gate-on voltage VGH of the third scan pulse SC3 to apply the initialization voltage Vini to the second node DTS in the initialization stage INIT. The third switch element M3 may include a gate electrode connected to a third gate line to which the third scan pulse SC3 is applied, a first electrode connected to the fourth node n4, and a second electrode connected to an INI line to which the initialization voltage Vini is applied.

The fourth switch element M4 may be turned off according to the gate-off voltage VEL of the first EM pulse EM1 to block a current path between the VDD line to which the pixel driving voltage ELVDD is applied and the third node DTD in the initialization stage INIT and the addressing stage WR. The fourth switch element M4 may be turned on according to the gate-on voltage VEH of the first EM pulse EM1 to connect the VDD line to the third node DTD in the sampling stage SMPL and the emission stage EMIS. The fourth switch element M4 may include a gate electrode connected to the fourth gate line to which the first EM pulse EM1 is applied, a first electrode connected to the VDD line, and a second electrode connected to the third node DTD.

The fifth switch element M5 may be turned off according to the gate-off voltage VEL of the second EM pulse EM2 to block a current path between the second node DTS and the fourth node n4 in the sampling stage SMPL and the addressing stage WR. The fifth switch element M5 may be turned on according to the gate-on voltage VEH of the second EM pulse EM2 to form a current path between the driving element DT and the light emitting element EL in the initialization stage INIT and the emission stage EMIS. The fifth switch element M5 may include a gate electrode connected to a fifth gate line to which the second EM pulse EM2 is applied, a first electrode connected to the second node DTS, and a second electrode connected to the fourth node n4.

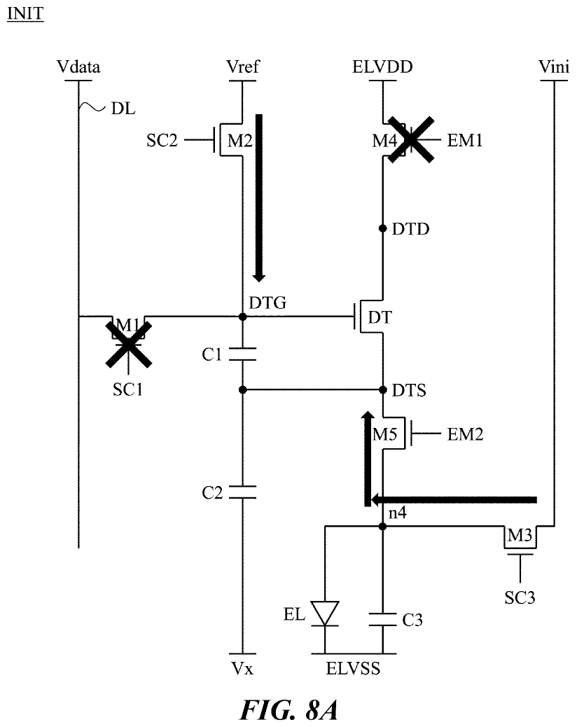

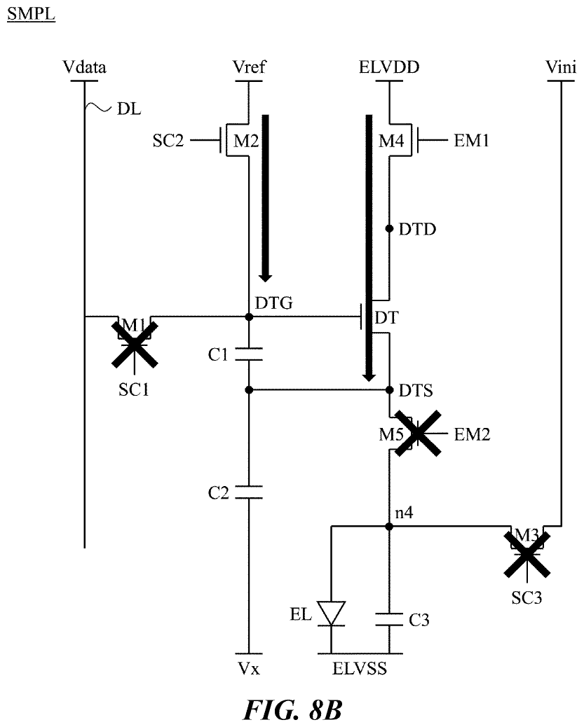

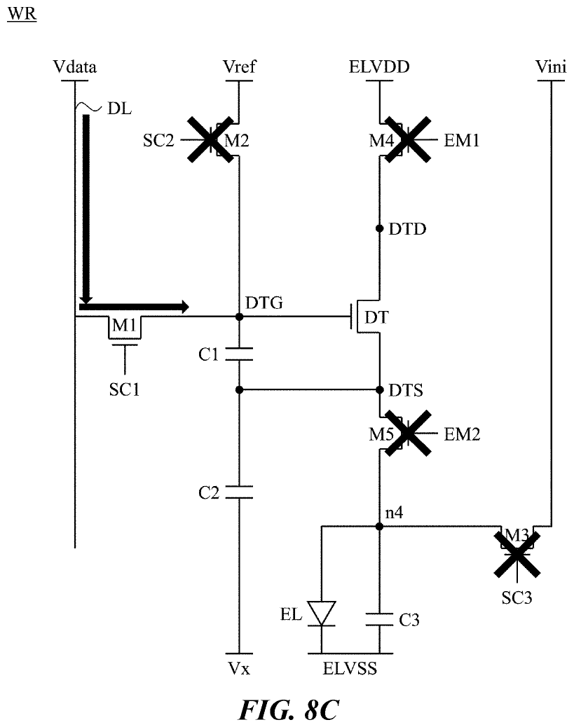

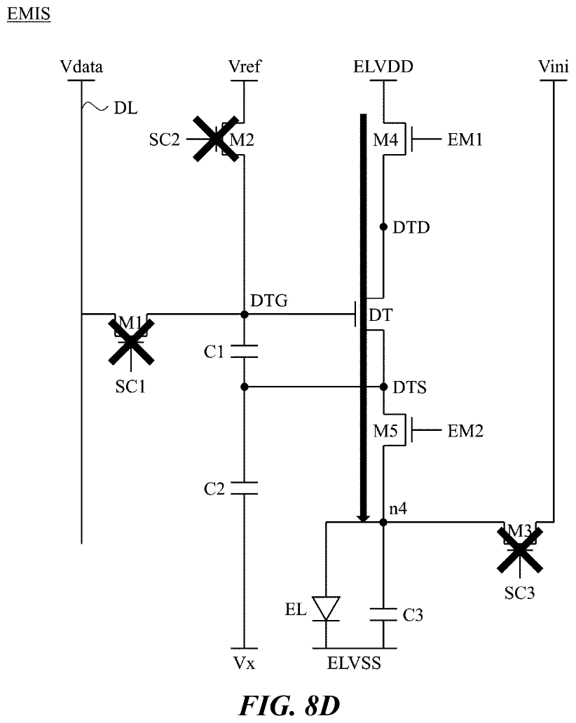

FIGS. 8A to 8D are circuit diagrams showing operating states of the pixel circuit corresponding to each operation of FIG. 7.

Referring to FIGS. 7 and 8A, in the initialization stage INIT, the second, third, and fifth switch elements M2, M3, and M5 may be turned on. In the initialization stage INIT, the first and fourth switch elements M1 and M4 may be turned off. The voltages at main nodes in the initialization stage INIT are DTD=Vref+Vth, DTG=Vref, and DTS=Vinit. “Vth” denotes the threshold voltage of the driving element DT. Therefore, the driving element DT may be turned on because the gate-source voltage (Vgs) thereof is Vref-Vinit that is higher than the threshold voltage (Vth) in the initialization stage INIT.

Referring to FIGS. 7 and 8B, in the sampling stage SMPL, while the second and fourth switch elements M2 and M4 may be turned on, the other switch elements M1, M3, and M5 may be turned off. In the sampling stage SMPL, when the voltage at the second node DTS increases and thus the gate-source voltage (Vgs) of the driving element DT reaches the threshold voltage (Vth), the driving element DT may be turned off. At the end of the sampling stage SMPL, the voltages at the main nodes are DTD=ELVDD, DTG=Vref, and DTS=Vref-Vth. Therefore, at the end of the sampling stage SMPL, the gate-source voltage (Vgs) of the driving element DT is Vgs=Vth. The sampled threshold voltage (Vth) of the driving element DT may be charged in the first capacitor C1.

Referring to FIGS. 7 and 8C, in the addressing stage WR, the first switch element M1 may be turned on to apply the data voltage Vdata of the pixel data to the first node DTG. At this time, the other switch elements M2, M3, M4, and M5 may be turned off. At the end of the addressing stage WR, the voltages at the main nodes may be changed to DTD=ELVDD, DTG=Vdata, and DTS=Vref−Vth+C′×(Vdata−Vref). Here, C′=C1/(C1+C2). The gate-source voltage (Vgs) of the driving element DT may be changed to Vgs=(1−C′)×(Vdata−Vref)+Vth in the addressing stage WR.

In the sampling stage SMPL and the addressing stage WR, the second node DTS may be electrically separated from the fourth node n4 as shown in FIGS. 8B and 8C. As a result, since the threshold voltage sampling and data addressing of the driving element DT are not affected by the resistance of the light emitting element EL and the process deviation of the light emitting element EL, the influence of the light emitting element EL on the luminance of the pixel can be excluded.

Referring to FIGS. 7 and 8D, in the emission stage EMIS, while the fourth and fifth switch elements M4 and M5 may be turned on, the other switch elements M1, M2, and M3 may be turned off. In the emission stage EMIS, the voltages at the main nodes may be changed as DTD=ELVDD, DTG=Vdata, and DTS=Vref−Vth+C′×(Vdata−Vref). In the emission stage EMIS, the voltage at the second node DTS may be equal to an anode voltage (Vel) of the light emitting element EL. The gate-source voltage (Vgs) of the driving element DT is Vgs=(1−C′)×(Vdata−Vref)+Vth in the emission stage EMIS.

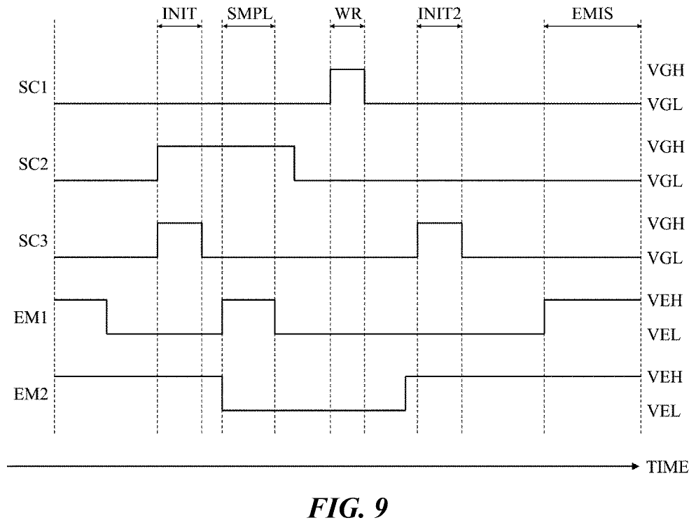

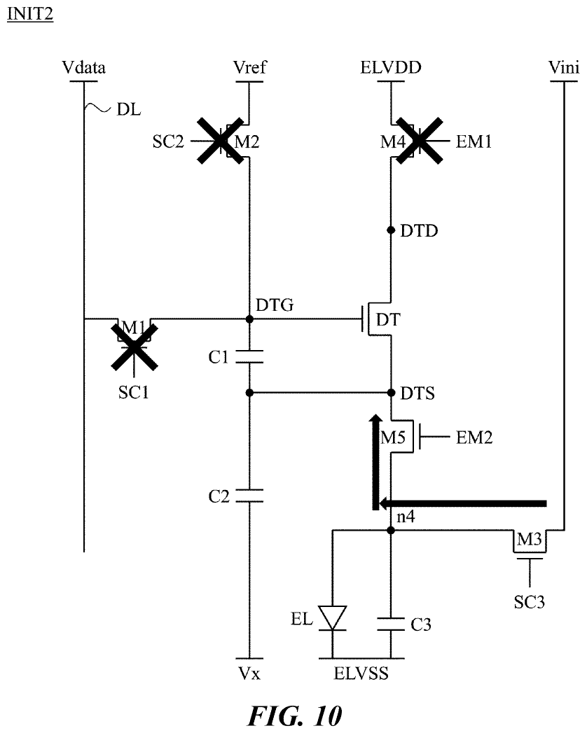

FIG. 9 is a waveform diagram showing a method of driving a pixel circuit according to another embodiment of the present specification. FIG. 10 is a circuit diagram showing a current flowing in the pixel circuit shown in FIG. 6 in a second initialization operation. Components that perform substantially the same function as the above-described embodiments are denoted by the same reference numerals, and overlapping descriptions thereof will be omitted.

Referring to FIGS. 7, 8A, 8B, 8C, 8D, 9, and 10, the display time of the pixel circuit may include a first initialization stage INIT1, a sampling stage SMPL set after the first initialization stage INIT1, an addressing stage WR set after the sampling stage SMPL, a second initialization stage INIT2 set after the addressing stage WR, and an emission stage EMIS set after the second initialization stage INIT2 as shown in FIG. 9.

The first scan pulse SC1 may be the gate-on voltage VGH in the addressing stage WR in synchronization with the data voltage Vdata of the pixel data. The first scan pulse SC1 may be the gate-off voltage VGL in the first initialization stage INIT1, the sampling stage SMPL, the second initialization stage INIT2, and the emission stage EMIS. The second scan pulse SC2 may be the gate-on voltage VGH in the first initialization stage INIT1 and the sampling stage SMPL. The second scan pulse SC2 may be the gate-off voltage VGL in the addressing stage WR, the second initialization stage INIT2, and the emission stage EMIS. The third scan pulse SC3 may be the gate-on voltage VGH in the first initialization stage INIT1 and the second initialization stage INIT2. The third scan pulse SC3 may be the gate-off voltage VGL in the sampling stage SMPL, the addressing stage WR, and the emission stage EMIS.

The first EM pulse EM1 may be the gate-off voltage VEL in the first initialization stage INIT1, the sampling stage WR, and the second initialization stage INIT2. The first EM pulse EM1 may be the gate-on voltage VEH in the sampling stage SMPL and the emission stage EMIS.

The second EM pulse EM2 may be the gate-on voltage VEH in the first initialization stage INIT1, the second initialization stage INIT2, and the emission stage EMIS. The second EM pulse EM2 may be the gate-off voltage VEL in the sampling stage SMPL and the addressing stage WR.

Referring to FIGS. 7, 8A, 8B, 8C, and 8D, in the first initialization stage INIT, the second, third, and fifth switch elements M2, M3, and M5 may be turned on. The first and fourth switch elements M1 and M4 may be turned off. In the sampling stage SMPL, while the second and fourth switch elements M2 and M4 may be turned on, the other switch elements M1, M3, and M5 may be turned off. In the addressing stage WR, the first switch element M1 may be turned on to apply the data voltage Vdata of the pixel data to the first node DTG. At this time, the other switch elements M2, M3, M4, and M5 may be turned off.

Referring to FIGS. 9 and 10, in the second initialization stage INIT2, while the third and fifth switch elements M3 and M5 may be turned on, the other switch elements M1, M2, and M4 may be turned off. In the second initialization stage INIT2, the voltage at the second node DTS may be initialized to DTS=Vinit. At this time, since the voltage at the first node DTG may also be increased as much as the initialization voltage Vinit, the gate-source voltage (Vgs) of the driving element DT may be maintained at the voltage set in the addressing stage WR.

In the emission stage EMIS, while the fourth and fifth switch elements M4 and M5 may be turned on, the other switch elements M1, M2, and M3 may be turned off. In the emission stage EMIS, the light emitting element EL may be driven by a current generated according to the gate-source voltage (Vgs) of the driving element DT to emit light with a luminance corresponding to a grayscale value of the pixel data.

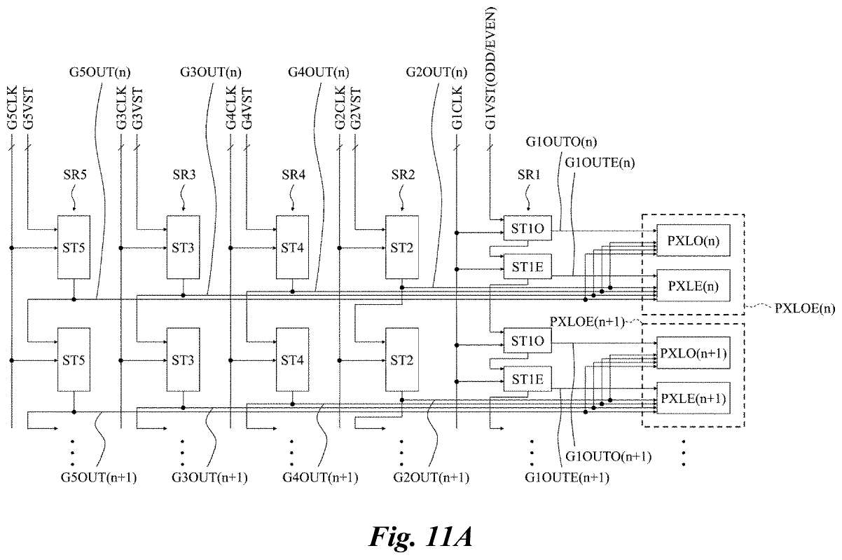

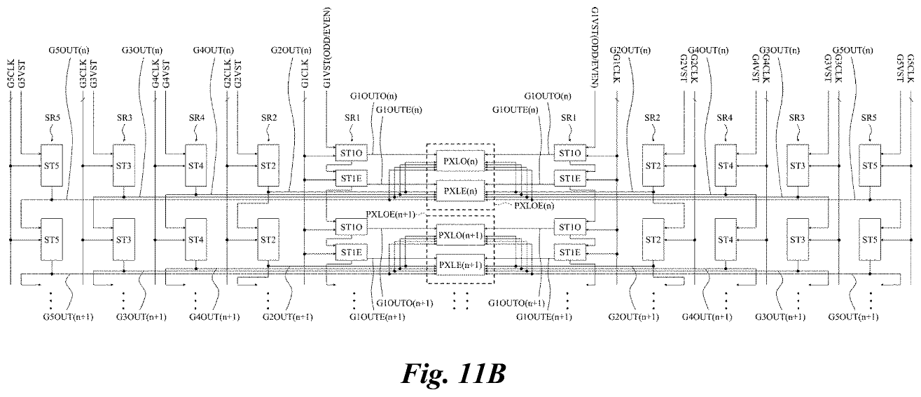

FIG. 11A is a view showing one embodiment in which an output signal of a gate driver and pixels are shared in the present specification. FIG. 11B is a view showing another embodiment in which the output signal of the gate driver and the pixels are shared in the present specification.

Referring to FIG. 11A, the pixel array may include a plurality of pixel line sets PXLOE(n) and PXLOE(n+1) (n is an odd-numbered or even number of 1 or more). Each of the plurality of pixel line sets PXLOE(n) and PXLOE(n+1) may include odd-numbered pixel lines PXLO(n) and PXLO(n+1) and even-numbered pixel lines PXLE(n) and PXLE(n+1).

For example, n may be 1. A first pixel line set PXLOE(1) may include an odd-numbered pixel line PXLO(1) and an even-numbered pixel line PXLE(1). A second pixel line set PXLOE(2) may include an odd-numbered pixel line PXLO(2) and an even-numbered pixel line PXLE(2).

For example, n may be 2. The second pixel line set PXLOE(2) may include the odd-numbered pixel line PXLO(2) and the even-numbered pixel line PXLE(2). A third pixel line set PXLOE(3) may include an odd-numbered pixel line PXLO(3) and an even-numbered pixel line PXLE(3).

For example, n may be 3. The third pixel line set PXLOE(3) may include the odd-numbered pixel line PXLO(3) and the even-numbered pixel line PXLE(3). A fourth pixel line set PXLOE(4) may include an odd-numbered pixel line PXLO(4) and an even-numbered pixel line PXLE(4).

For example, n may be 4. The fourth pixel line set PXLOE(4) may include an odd-numbered pixel line PXLO(4) and an even-numbered pixel line PXLE(4). A fifth pixel line set PXLOE(5) may include an odd-numbered pixel line PXLO(5) and an even-numbered pixel line PXLE(5).

Each of the odd-numbered pixel lines PXLO and the even-numbered pixel lines PXLE may include pixels of one line disposed in a line direction (e.g., an X-axis direction in FIG. 1A or 1B) in the pixel array of the display panel. The pixels disposed in one pixel line may share the gate lines.

The gate driver may include a plurality of shift registers. The gate driver may include a first shift register SR1 for sequentially outputting a pulse of a first gate signal G1OUT, the second shift register SR2 for sequentially outputting a pulse of a second gate signal G2OUT, a third shift register SR3 for sequentially outputting a pulse of a third gate signal G3OUT, a fourth shift register SR4 for sequentially outputting a pulse of a fourth gate signal G4OUT, and a fifth shift register SR5 for sequentially outputting a pulse of a fifth gate signal G5OUT.

The first gate signal G1OUT may be a first gate pulse. The second gate signal G2OUT may be a second gate pulse. The third gate signal G3OUT may be a third gate pulse. The fourth gate signal G4OUT may be a first EM pulse. The fifth gate signal G5OUT may be a second EM pulse.

The first shift register SR1 may include a plurality of odd-numbered signal transmission units ST1O for receiving a first odd-numbered start pulse G1VST(ODD) and a first clock G1CLK and sequentially outputting pulses of odd-numbered gate signals G1OUTO(n) and G1OUTO(n+1).

The first shift register SR1 may include a plurality of even-numbered signal transmission units ST1E for receiving a first even-numbered start pulse G1VST(EVEN) and the first clock G1CLK and sequentially outputting pulses of even-numbered gate signals G1OUTE(n) and G1OUTE(n+1).

A pulse width of the first gate signal G1OUT may be one horizontal period.

The first clock G1CLK may include two or more shift clocks having different phases.

A carry signal may be transmitted between the neighboring odd-numbered signal transmission unit ST1O and even-numbered signal transmission unit ST1E.

To adjust the luminance difference between the pixel lines, timings of phases, pulse widths, etc., of the pulses of the gate signals G1OUTO(n) and G1OUTO(n+1) applied to the odd-numbered pixel lines and the pulses of the gate signals G1OUTE(n) and G1OUTE(n+1) applied to the even-numbered pixel lines may be adjusted differently.

After the pulse of the odd-numbered gate signal G1OUTO(n) is applied to an n^{th} odd-numbered pixel line PXLO(n), a pulse of the even-numbered gate signal G1OUTE(n) may be applied to an n^{th} even-numbered pixel line PXLE(n). Subsequently, after the pulse of the odd-numbered gate signal G1OUTO(n+1) is applied to an (n+1)^{th} odd-numbered pixel line PXLO(n+1), a pulse of the even-numbered gate signal G1OUTE(n+1) may be applied to an (n+1)^{th} even-numbered pixel line PXLE(n+1).

For example, n may be 1. After the pulse of the odd-numbered gate signal G1OUTO(1) is applied to the first odd-numbered pixel line PXLO(1), a pulse of the even-numbered gate signal G1OUTE(1) may be applied to the first even-numbered pixel line PXLE(1). Subsequently, after a pulse of the odd-numbered gate signal G1OUTO(2) is applied to the second odd-numbered pixel line PXLO(2), a pulse of the even-numbered gate signal G1OUTE(2) may be applied to the second even-numbered pixel line PXLE(2).

For example, n may be 2. The gate signal G2OUT(2) may be simultaneously applied to the second pixel line set PXLOE(2) including the adjacent second odd-numbered pixel line PXLO(2) and the second even-numbered pixel line PXLE(2). The gate signal G2OUT(3) may be simultaneously applied to the third pixel line set PXLOE(3) including the adjacent third odd-numbered pixel line PXLO(3) and the third even-numbered pixel line PXLE(3).

The second shift register SR2 may include a plurality of signal transmission units ST2 cascade-connected to each other for receiving a second start pulse G2VST and a second clock G2CLK and sequentially outputting a pulse of the second gate signal G2OUT.

A pulse width of the second gate signal G2OUT may be set to be greater than one horizontal period and simultaneously applied to the pixels disposed in the plurality of pixel lines.

The clock G2CLK may include two or more shift clocks having different phases.

A carry signal may be transmitted between the signal transmission units ST2.

An n^{th} gate signal G2OUT(n) may be simultaneously applied to the n^{th} pixel line set PXLOE(n) including the adjacent n^{th} odd-numbered pixel line PXLO(n) and the n^{th} even-numbered pixel line PXLE(n). An (n+1) gate signal G2OUT(n+1) may be simultaneously applied to the (n+1)^{th} pixel line set PXLOE(n+1) including the adjacent (n+1)^{th} odd-numbered pixel line PXLO(n+1) and the (n+1)^{th} even-numbered pixel line PXLE(n+1).

For example, n may be 1. The gate signal G2OUT(1) may be simultaneously applied to the first pixel line set PXLOE(1) including the adjacent first odd-numbered pixel line PXLO(1) and the first even-numbered pixel line PXLE(1). The gate signal G2OUT(2) may be simultaneously applied to the second pixel line set PXLOE(2) including the adjacent second odd-numbered pixel line PXLO(2) and the second even-numbered pixel line PXLE(2).

For example, n may be 2. The gate signal G2OUT(2) may be simultaneously applied to the second pixel line set PXLOE(2) including the adjacent second odd-numbered pixel line PXLO(2) and the second even-numbered pixel line PXLE(2). The gate signal G2OUT(3) may be simultaneously applied to the third pixel line set PXLOE(3) including the adjacent third odd-numbered pixel line PXLO(3) and the third even-numbered pixel line PXLE(3).

The third shift register SR3 may include a plurality of signal transmission units ST3 cascade-connected to each other for receiving a third start pulse G3VST and a third clock G3CLK and sequentially outputting a pulse of the third gate signal G3OUT.

A pulse width of the third gate signal G3OUT may be set to be greater than one horizontal period and simultaneously applied to the pixels disposed in the plurality of pixel lines.

The clock G3CLK may include two or more shift clocks having different phases.

A carry signal may be transmitted between the signal transmission units ST3.

A gate signal G3OUT(n) may be simultaneously applied to the n^{th} pixel line set PXLOE(n) including the adjacent n^{th} odd-numbered pixel line PXLO(n) and the n^{th} even-numbered pixel line PXLE(n). A gate signal G3OUT(n+1) may be simultaneously applied to the (n+1)^{th} pixel line set PXLOE(n+1) including the adjacent (n+1)^{th} odd-numbered pixel line PXLO(n+1) and (n+1)^{th} even-numbered pixel line PXLE(n+1).

For example, n may be 1. The gate signal G3OUT(1) may be simultaneously applied to the first pixel line set PXLOE(1) including the adjacent first odd-numbered pixel line PXLO(1) and the first even-numbered pixel line PXLE(1). The gate signal G3OUT(2) may be simultaneously applied to the second pixel line set PXLOE(2) including the adjacent second odd-numbered pixel line PXLO(2) and the second even-numbered pixel line PXLE(2).

For example, n may be 2. The gate signal G3OUT(2) may be simultaneously applied to the second pixel line set PXLOE(2) including the adjacent second odd-numbered pixel line PXLO(2) and the second even-numbered pixel line PXLE(2). The gate signal G3OUT(3) may be simultaneously applied to the third pixel line set PXLOE(3) including the adjacent third odd-numbered pixel line PXLO(3) and the third even-numbered pixel line PXLE(3).

The fourth shift register SR4 may include a plurality of signal transmission units ST4 cascade-connected to each other for receiving a fourth start pulse G4VST and a fourth clock G4CLK and sequentially outputting a pulse of the fourth gate signal G4OUT.

A pulse width of the fourth gate signal G4OUT may be set to be greater than one horizontal period and simultaneously applied to the pixels disposed in the plurality of pixel lines.

The clock G4CLK may include two or more shift clocks having different phases.

A carry signal may be transmitted between the signal transmission units ST4.

A gate signal G4OUT(n) may be simultaneously applied to the n^{th} pixel line set PXLOE(n) including the adjacent n^{th} odd-numbered pixel line PXLO(n) and the n^{th} even-numbered pixel line PXLE(n). A gate signal G4OUT(n+1) may be simultaneously applied to the (n+1)^{th} pixel line set PXLOE(n+1) including the adjacent (n+1)^{th} odd-numbered pixel line PXLO(n+1) and (n+1)^{th} even-numbered pixel line PXLE(n+1).

For example, n may be 1. The gate signal G4OUT(1) may be simultaneously applied to the first pixel line set PXLOE(1) including the adjacent first odd-numbered pixel line PXLO(1) and the first even-numbered pixel line PXLE(1). The gate signal G4OUT(2) may be simultaneously applied to the second pixel line set PXLOE(2) including the adjacent second odd-numbered pixel line PXLO(2) and the second even-numbered pixel line PXLE(2).

For example, n may be 2. The gate signal G4OUT(2) may be simultaneously applied to the second pixel line set PXLOE(2) including the adjacent second odd-numbered pixel line PXLO(2) and the second even-numbered pixel line PXLE(2). The gate signal G4OUT(3) may be simultaneously applied to the third pixel line set PXLOE(3) including the adjacent third odd-numbered pixel line PXLO(3) and the third even-numbered pixel line PXLE(3).

The fifth shift register SR5 may include a plurality of signal transmission units ST5 cascade-connected to each other for receiving a fifth start pulse G5VST and a fifth clock G5CLK and sequentially outputting a pulse of the fifth gate signal G5OUT.

A pulse width of the fifth gate signal G5OUT may be set to be greater than one horizontal period and simultaneously applied to the pixels disposed in the plurality of pixel lines.

The clock G5CLK may include two or more shift clocks having different phases.

A carry signal may be transmitted between the signal transmission units ST5.

A gate signal G5OUT(n) may be simultaneously applied to the n^{th} pixel line set PXLOE(n) including the adjacent n^{th} odd-numbered pixel line PXLO(n) and the n^{th} even-numbered pixel line PXLE(n). A gate signal G5OUT(n+1) may be simultaneously applied to the (n+1)^{th} pixel line set PXLOE(n+1) including the adjacent (n+1)^{th} odd-numbered pixel line PXLO(n+1) and (n+1)^{th} even-numbered pixel line PXLE(n+1).

For example, n may be 1. The gate signal G5OUT(1) may be simultaneously applied to the first pixel line set PXLOE(1) including the adjacent first odd-numbered pixel line PXLO(1) and the first even-numbered pixel line PXLE(1). The gate signal G5OUT(2) may be simultaneously applied to the second pixel line set PXLOE(2) including the adjacent second odd-numbered pixel line PXLO(2) and the second even-numbered pixel line PXLE(2).

For example, n may be 2. The gate signal G5OUT(2) may be simultaneously applied to the second pixel line set PXLOE(2) including the adjacent second odd-numbered pixel line PXLO(2) and the second even-numbered pixel line PXLE(2). The gate signal G5OUT(3) may be simultaneously applied to the third pixel line set PXLOE(3) including the adjacent third odd-numbered pixel line PXLO(3) and the third even-numbered pixel line PXLE(3).

Referring to FIG. 11B, the gate driver may be disposed in the left non-display area and the right non-display area of the display panel to apply the gate signals G1OUT, G2OUT, G3OUT, G4OUT, and G5OUT to the pixel lines in a double feeding method. In the double feeding method, the gate signal may be applied simultaneously at both ends of the gate line. The gate driver may be provided in the above manner at both sides facing each other of the display panel, thereby reducing signal distortion due to a load difference for each location. In an embodiment, at least some circuits of the gate driver may be disposed in the display area.

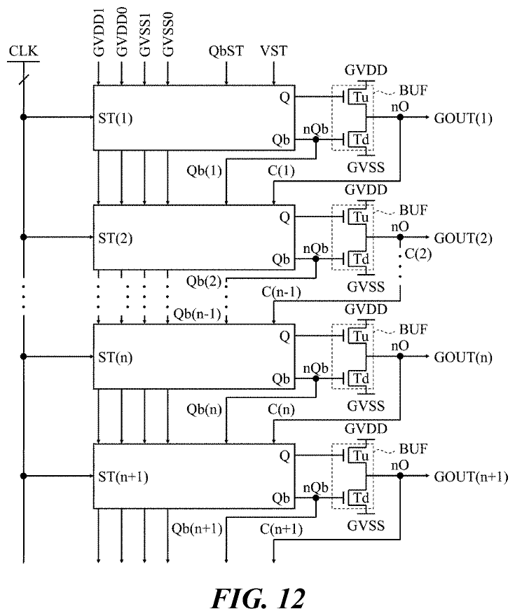

FIG. 12 is a view schematically showing a shift register of the gate driver. Other shift registers included in the gate driver may be implemented as substantially the same circuit.

Referring to FIG. 12, the shift register may be implemented as a known shift register circuit for driving a display panel. The shift register may include a plurality of signal transmission units ST(1) to ST(n) cascade-connected to each other. The signal transmission units ST(1) to ST(n) may be GIP elements formed using a GIP method. The signal transmission unit may be construed as a stage of the shift register.

When compared to the uppermost signal transmission unit ST(1), the configurations and connection relationships of the signal transmission units ST(2) to ST(n) except for the uppermost signal transmission unit ST(1) are substantially the same as those of the uppermost signal transmission unit ST(1), except that the remaining signal transmission units ST(2) to ST(n) receive carry signals C(1) to C(n) instead of an external start signal VST, receive a signal Qb(n−1) applied from a Qb node in the previous signal transmission unit instead of a Qb start signal QbST, and output the gate signals GOUT(1) to GOUT(n) having different phases.

When comparing the signal transmission units ST(2) to ST(n) except for the uppermost signal transmission unit ST(1), the configurations and connection relationships of the signal transmission units ST(2) to ST(n) are substantially the same as each other, except that the remaining signal transmission units ST(2) to ST(n) receive the clock signals CLK having different phases and output the gate signals GOUT(2) to GOUT(n) having different phases.

The clock CLK may include two or more shift clocks having different phases.

Each of the signal transmission units may include a buffer transistor BUF that outputs the pulse of the gate signal by charging/discharging an output node nO in response to voltages at a CLK node to which the clock CLK is input, a VST node to which the start pulse VST or the carry signal C(n) from the previous signal transmission unit or the previous signal transmission unit is input, a first control node Q, a second control node Qb, an output node nO, and control nodes Q and Qb.

“Previous signal transmission unit” is a signal transmission unit for outputting a previous gate signal preceding an output signal of a signal transmission unit for outputting a current gate signal. For example, in the case of an N^{th} signal transmission unit for outputting an N^{th} gate signal, the previous signal transmission unit may be an (N-i)^{th} signal transmission unit (N is a natural number and i is a natural number between 1 and 6).

“Immediate previous signal transmission unit” is a signal transmission unit for outputting a previous gate signal preceding an output signal of a signal transmission unit for outputting a current gate signal.” For example, in the case of the N^{th} signal transmission unit for outputting the N^{th} gate signal, the immediate previous signal transmission unit may be the (N-i)^{th} signal transmission unit (i is 1).

An operation of the uppermost signal transmission unit ST(1) may be activated according to the external start signal, and an operation of the second uppermost signal transmission unit ST(2) to the lowest signal transmission unit ST(n) may be activated according to a carry signal C(n−1) of the previous signal transmission unit. The carry signal C(n−1) is the gate signal of the previous signal transmission unit and may be an internal start signal.

A first high potential voltage GVDD0, a second high potential voltage GVDD1, a first low potential voltage GVSS0, and a second low potential voltage GVSS1 may be applied to each of the signal transmission units ST(1) to ST(n). The first high potential voltage GVDD0, the second high potential voltage GVDD1, the first low potential voltage GVSS0, and the second low potential voltage GVSS1 may all be DC voltages (or constant voltages). The first high potential voltage GVDD0, the second high potential voltage GVDD1, the first low potential voltage GVSS0, and the second low potential voltage GVSS1 that are supplied to the signal transmission unit may be supplied to the gate driver through one line.

Phases of the clocks CLK may be shifted sequentially. The signal transmission units ST may receive one or more clocks.

In the shown embodiment, CLK nodes of each of the signal transmission units ST may be connected to clock lines disposed in a non-display area of the display panel to receive the clock CLK. However, the nodes are not limited to the shown embodiment, and may receive the clock CLK through the clock lines disposed in the display area.

The first signal transmission unit ST(1) may receive the clock CLK, the start pulse VST (hereinafter referred to as “VST signal”), and the Qb start pulse QbST (hereinafter referred to as “QbST signal”) and output a pulse of the gate signal GOUT(1), a pulse of a voltage level signal Qb(1) applied to a Qb node nQb, and a pulse of the carry signal C(1).

The second signal transmission unit ST(2) may receive the clock CLK, the carry signal C(1), and the voltage level signal Qb(1) applied to the Qb node nQb of the previous signal transmission unit and output a pulse of the gate signal GOUT(2), a pulse of a voltage level signal Qb(2) applied to the Qb node nQb, and a pulse of the carry signal C(2).

The n^{th} signal transmission unit ST(n) may receive the clock CLK, the carry signal C(n−1), and a voltage level signal Qb(n−1) applied to the Qb node (nQb) of the previous signal transmission unit ST(n−1) and output a pulse of a gate signal GOUT(n), a pulse of the voltage level signal Qb(n) applied to the Qb node nQb, and a pulse of the carry signal C(n) (n is a positive integer of 1 or more).

The buffer transistor BUF may include a pull-up transistor Tu controlled based on a voltage at the first control node Q and a pull-down transistor Td controlled based on a voltage at the second control node Qb.

The pull-up transistor Tu may be turned on according to the voltage at the first control node Q to charge the voltage at the output node nO to the gate-on voltage GVDD. The pull-up transistor Tu may include a gate electrode connected to the first control node Q, a first electrode to which the gate-on voltage GVDD is applied, and a second electrode connected to the output node nO.

The pull-down transistor Td may be turned on according to the voltage at the second control node Qb and supply the gate-off voltage GVSS to the output node nO. The pull-down transistor Td may include a gate electrode connected to the second control node Qb, a first electrode connected to the output node nO, and a second electrode to which the gate-off voltage GVSS is applied.

As will be described below, the output node nO may include a first output node connected to a first output terminal that outputs the pulse of the carry signal C(n) and a second output node connected to a second output terminal that outputs the pulses of the gate signals GOUT(1) to GOUT(n).

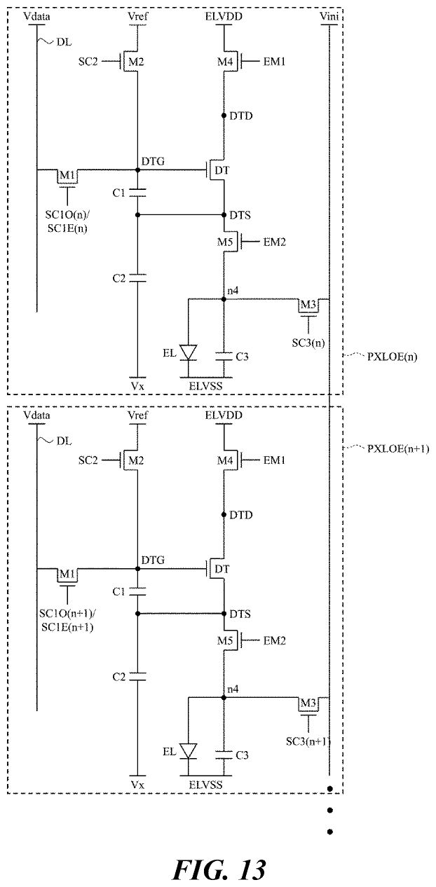

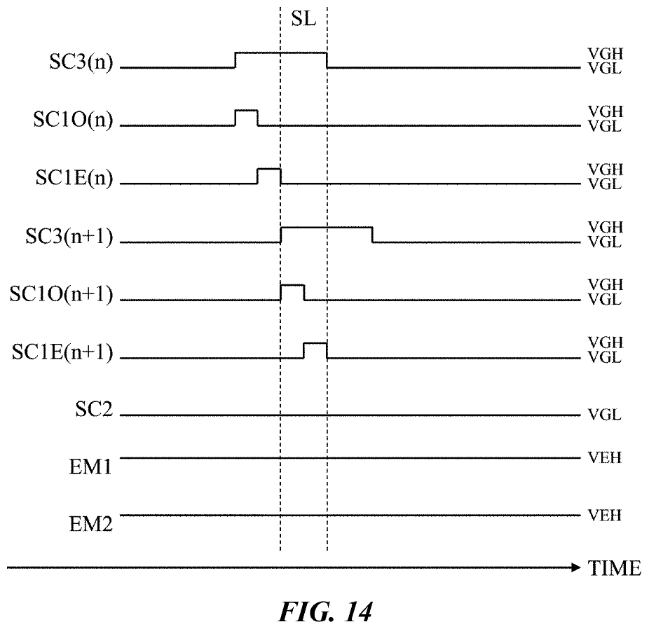

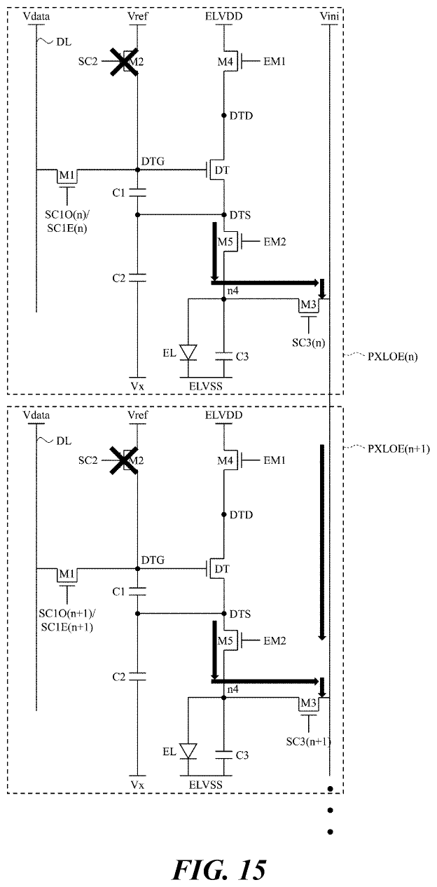

FIG. 13 is a circuit diagram showing the pixel circuit according to one embodiment of the present specification. FIG. 14 is a waveform diagram showing voltage levels of signals input to switch elements shown in FIG. 13 during a sensing time for external compensation of the display device. FIG. 15 is a circuit diagram showing operating state of the pixel circuit during the sensing time for external compensation of the display device. Components that perform substantially the same function as the above-described embodiments are denoted by the same reference numerals, and overlapping descriptions thereof will be omitted.

Referring to FIG. 13, as shown in the drawing, only two pixel circuits are exemplarily shown in a vertical direction due to space limitations. The display device may include a plurality of pixel line sets PXLOE(n) and PXLOE(n+1) (n is an odd or even number of 1 or more). Each of the plurality of pixel line sets PXLOE(n) and PXLOE(n+1) may include odd-numbered pixel lines PXLO(n) and PXLO(n+1) and even-numbered pixel lines PXLE(n) and PXLE(n+1).

The pixel circuits included in each of the pixel line set PXLOE(n) and PXLOE(n+1) may further include an external compensation circuit unit YB shown in FIG. 3.

The n^{th} pixel line set PXLOE(n) may include an n^{th} odd-numbered pixel line PXLO(n) and an n^{th} even-numbered pixel line PXLE(n) vertically adjacent to each other. The (n+1)^{th} pixel line set PXLOE(n+1) may include the (n+1)^{th} odd-numbered pixel line PXLO(n+1) and the (n+1)^{th} even-numbered pixel line PXLE(n+1) vertically adjacent to each other.

However, the term “vertically” adjacent is an example, and a pixel line defines pixels that share a gate line, and thus the positional relationship between adjacent pixel lines may be appropriately modified according to an operator.

The n^{th} odd-numbered pixel line PXLO(n) and the n^{th} even-numbered pixel line PXLE(n) may share an INI line to which the initialization voltage Vini is applied. The (n+1)^{th} odd-numbered pixel line PXLO(n+1) and the (n+1)^{th} even-numbered pixel line PXLE(n+1) may share the INI line to which the initialization voltage Vini is applied. The n^{th} pixel line set PXLOE(n) and the (n+1)^{th} pixel line set PXLOE(n+1) may share the INI line to which the initialization voltage Vini is applied.

Referring to FIG. 14, for the threshold voltage (Vth) sensing time of the driving element DT for external compensation of the display device, the second scan pulse SC2 may be the gate-off voltage VGL, and the first EM pulse EM1 and the second EM pulse EM2 may be the gate-on voltage VEH.

After a first odd-numbered scan pulse SC1O(n) of the gate-on voltage VGH is applied to the n^{th} odd-numbered pixel line PXLO(n), a first even-numbered scan pulse SC1E(n) at the gate-on voltage VGH may be applied to the n^{th} even-numbered pixel line PXLE(n).

After a first odd-numbered scan pulse SC1O(n+1) at the gate-on voltage VGH is applied to the (n+1)^{th} odd-numbered pixel line PXLO(n+1), the first even-numbered scan pulse SC1E(n+1) at the gate-on voltage VGH may be applied to the n^{th} even-numbered pixel line PXLE(n).

After the n^{th} first scan pulses SC1O(n)/SC1E(n) at the gate-on voltage VGH are applied to the n^{th} pixel line set PXLOE(n), the (n+1)^{th} first scan pulse SC10(n+1)/SC1E(n+1) at the gate-on voltage VGH may be applied to the (n+1)^{th} pixel line set PXLOE(n+1).

The n^{th} third scan pulse SC3(n) at the gate-on voltage VGH may be simultaneously applied to the n^{th} pixel line set PXLOE(n) including the n^{th} odd-numbered pixel line PXLO(n) and the n^{th} even-numbered pixel line PXLE(n).

An (n+1)^{th} third scan pulse SC3(n+1) at the gate-on voltage VGH may be simultaneously applied to the (n+1)^{th} pixel line set PXLOE(n+1) including the (n+1)^{th} odd-numbered pixel line PXLO(n+1) and the (n+1)^{th} even-numbered pixel line PXLE(n+1).

The n^{th} first scan pulses SC1O(n)/SC1E(n) at the gate-on voltage VGH may be applied while the n^{th} third scan pulse SC3(n) at the gate-on voltage VGH is applied.

The (n+1)^{th} first scan pulses SC1O(n+1)/SC1E(n+1) at the gate-on voltage VGH may be applied while the (n+1)^{th} third scan pulse SC3(n+1) at the gate-on voltage VGH is applied.

The n^{th} first scan pulses SC1O(n)/SC1E(n) at the gate-on voltage VGH may be applied in synchronization with a rising edge of the n^{th} third scan pulse SC3(n) at the gate-on voltage VGH.

The (n+1)^{th} first scan pulses SC1O(n)/SC1E(n) at the gate-on voltage VGH may be applied in synchronization with a rising edge of the (n+1)^{th} third scan pulse SC3(n+1) at the gate-on voltage VGH.

Referring to FIGS. 14 and 15, for the threshold voltage (Vth) sensing time of the driving element DT for external compensation of the display device, the second switch element M2 to which the second scan pulse SC2 is applied may be turned off, and the fourth switch element M4 and the fifth switch element M5 to which the first EM pulse EM1 and the second EM pulse EM2 are applied may be turned on.

In an SL section, the third scan pulse SC3(n+1) applied to the (n+1)^{th} pixel line set PXLOE(n+1) may be maintained at the gate-on voltage VGH in a section in which the third scan pulse SC3(n) applied to the n^{th} pixel line set PXLOE(n) is maintained at the gate-on voltage VGH. In the SL section, a section in which the third scan pulse SC3(n) applied to the n^{th} pixel line set PXLOE(n) is maintained at the gate-on voltage VGH and a section in which the third scan pulse SC3(n+1) applied to the (n+1)^{th} pixel line set PXLOE(n+1) is maintained at the gate-on voltage VGH may partially overlap each other.

For threshold voltage (Vth) sensing, the third scan pulse SC3(n+1) at the gate-on voltage VGH may be simultaneously input to the (n+1)^{th} odd-numbered pixel line PXLO(n+1) and the (n+1)^{th} even-numbered pixel line PXLE(n+1) that are included in the (n+1)^{th} pixel line set PXLOE(n+1). In this case, a sensing load of the corresponding sensing line may be increased by the third scan pulse SC3(n) at the gate-on voltage VGH applied to the n^{th} pixel line set PXLOE(n). For example, the capacitive load may be increased due to an increase in the capacitance of the sensing line. Therefore, there may a problem that a sensing error may be increased due to an increase in the influence of the sensing time and noise.

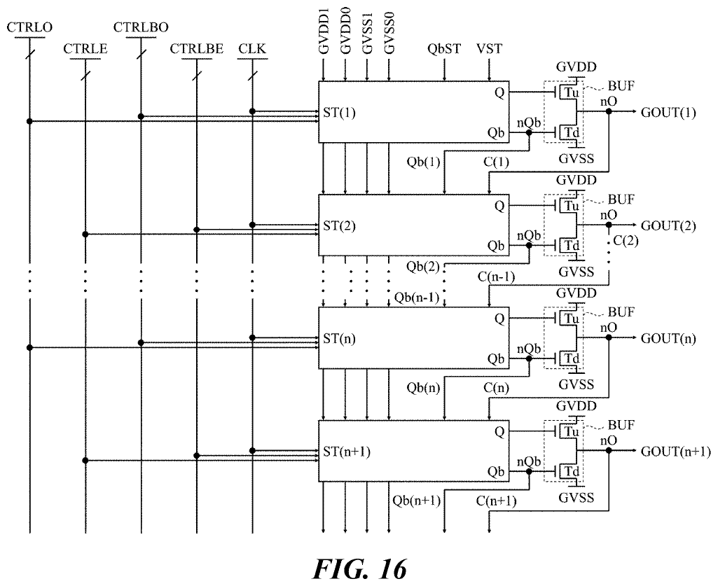

FIG. 16 is a view schematically showing the shift register of the gate driver according to one embodiment of the present specification. Other shift registers included in the gate driver may be implemented as substantially the same circuit. Components that perform substantially the same function as the above-described embodiments are denoted by the same reference numerals, and overlapping descriptions thereof will be omitted.

Referring to FIG. 16, the shift register may sequentially output the gate signal GOUT including any one selected from the group consisting of the above-described second gate signal G2OUT, third gate signal G3OUT, fourth gate signal G4OUT, and fifth gate signal G5OUT. In an exemplary embodiment, the gate signal GOUT may be the third gate signal G3OUT. For example, the shift register may be the third shift register for outputting the third scan pulse.

The gate signal GOUT may be simultaneously applied to pixels disposed on a plurality of pixel lines. The gate signal GOUT(n) may be simultaneously applied to the n^{th} pixel line set including the n^{th} odd-numbered pixel line and the n^{th} even-numbered pixel line adjacent to each other. A gate signal GOUT(n+1) may be simultaneously applied to the (n+1)^{th} pixel line set including the (n+1)^{th} odd-numbered pixel line and the (n+1)^{th} even-numbered pixel line adjacent to each other.

For example, n may be 1. The gate signal GOUT(1) may be simultaneously applied to the first pixel line set including the first odd-numbered pixel line and the first even-numbered pixel line adjacent to each other. A gate signal GOUT(n2) may be simultaneously applied to the second pixel line set including the second odd-numbered pixel line and the second even-numbered pixel line adjacent to each other.

The gate signal simultaneously applied to the pixels disposed in the plurality of pixel lines may be any one of the above-described second scan pulse, third scan pulse, first EM pulse, and second EM pulse. In an exemplary embodiment, the gate signal simultaneously applied to the pixels disposed in the plurality of pixel lines may be the above-described third scan pulse.

Since the signal output from one signal transmission unit ST is simultaneously transmitted to the pixel line set including two pixel lines, the number of signal transmission units ST(1), ST(2), . . . may be half or substantially half the number of pixel lines disposed on the display panel. Since one pixel line set shares one signal transmission unit ST, the number of signal transmission units ST(1), ST(2), . . . may be half or substantially half the number of pixel lines disposed on the display panel.

Each of the signal transmission units may include a CTRL node to which a control signal CTRL is input and a plurality of CTRLB nodes to which a control bar signal CTRLB is input. The control bar signal CTRLB may be referred to as an inverted control signal CTRLB. The control bar signal CTRLB is generated to have a phase inverted from that of the control signal CTRL and is an inverted signal of the control signal CTRL. The control signal CTRL and the control bar signal CTRLB have inverse phases with each other and have a 180 degree difference in phase. The control bar signal CTRLB may be an inverse phase signal of the control signal CTRL. For example, when the control signal CTRL is the gate-on voltage, the control bar signal CTRLB may be the gate-off voltage. For example, when the control signal CTRL is the gate-off voltage, the control bar signal CTRLB may be the gate-on voltage.

The control signal CTRL may include an odd-numbered control signal CTRLO input to the odd-numbered signal transmission units ST(1), . . . and an even-numbered control signal CTRLE input to the even-numbered signal transmission units ST(2), . . . .

The control bar signal CTRLB may include an odd-numbered control bar signal CTRLBO input to the odd-numbered signal transmission units ST(1), . . . and an even-numbered control bar signal CTRLBE input to the even-numbered signal transmission units ST(2), . . . .

Both the control signal CTRL and the control bar signal CTRLB may be supplied to each of the signal transmission units ST(1), ST(2), . . . .

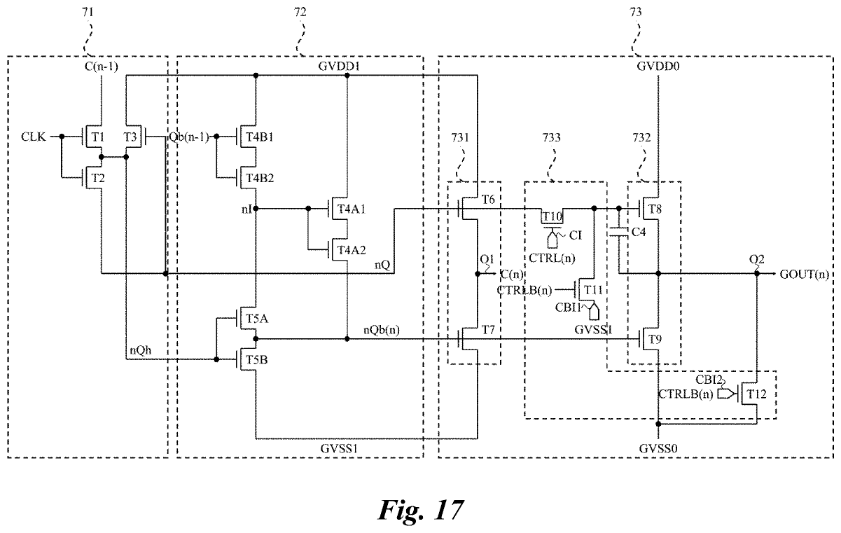

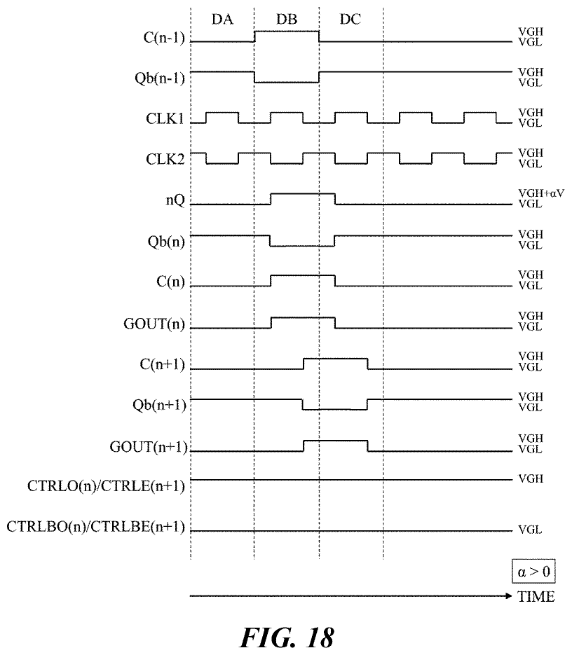

FIG. 17 is a circuit diagram specifically showing a signal transmission unit included in the gate driver according to one embodiment of the present specification. FIG. 18 is a waveform diagram showing input/output waveforms during a display time in the gate driver according to one embodiment of the present specification.

Referring to FIGS. 17 and 18, the signal transmission unit may include a plurality of transistors T1 to T12, a plurality of capacitors C3 to C5, and nodes connecting the transistors and the capacitors.

The first to twelfth transistors T1 to T12 may be implemented as n-channel oxide TFTs. The n-channel TFT may be turned on in response to the gate high voltage VGH and turned off in response to the gate low voltage VGL. In the case of the n-channel transistor, the gate-on voltage may be the gate high voltage VGH, and the gate-off voltage may be the gate low voltage VGL.

The first low potential voltage GVDD0 may be set to be higher than the second low potential voltage GVDD1.

The circuit diagram shown is a circuit of the n^{th} signal transmission unit ST(n) (n is a positive integer). When the dummy stage is omitted and n is 1, the carry signal C(n−1) may be the external start signal VST (see FIG. 16), and the Qb signal Qb(n−1) may be the QbST signal in FIG. 16. Other signal transmission units may also be implemented as substantially the same circuit as the n^{th} signal transmission unit ST(n).

The signal transmission unit may include a first control node nQ (hereinafter referred to as “Q node”), a second control node nQb(n) (hereinafter referred to as “Qb node”), a first circuit unit 71, a second circuit unit 72, and a third circuit unit 73.

The first circuit unit 71 may serve to control charging and discharging of the Q node nQ and the Qb node nQb(n). The first circuit unit 71 may supply the voltage of the (n−1)^{th} carry signal C(n−1) from the (n−1)^{th} signal transmission unit ST(n−1), which is the previous signal transmission unit, to the Q node nQ, when the clock CLK is a voltage that is higher than or equal to the gate-on voltage VGH, to charge the Q node nQ. The first circuit unit 71 may include first to third transistors T1, T2, and T3.

The first transistor T1 may be turned on when the clock CLK is the gate-on voltage VGH to supply the voltage of the carry signal C(n−1) to a Qh node nQh. The first transistor T1 may include a gate electrode to which the clock CLK is applied, a first electrode to which the (n−1)^{th} carry signal C(n−1) is applied, and a second electrode connected to the Qh node nQh.

The gate-on voltage VGH of the clock CLK may be set to be lower than the gate-on voltages VGH of the switch elements in the pixel circuit. When the gate-on voltage VGH of the clock CLK is set relatively low, when a threshold voltage (Vth) of the first transistor T1 may be shifted to negative polarity (−Vth) in a charging process of the Q node nQ, the Q node nQ may be in a floating state. Therefore, it is possible to improve voltage boosting of the Q node nQ.

The second transistor T2 may be turned on, when the clock CLK is the gate-on voltage VGH, to supply the voltage of the Qh node nQh to the Q node nQ to charge the Q node. The second transistor T2 may include a gate electrode to which the clock CLK is applied, a first electrode connected to the Qh node nQh, and a second electrode connected to the Q node nQ.

The first and second transistors T1 and T2 may be connected in series. The first and second transistors T1 and T2 may be connected in series between the node to which the (n−1)^{th} carry signal C(n−1) is applied and the Qh node nQh.

The third transistor T3 may be turned on when the Q node nQ is charged to supply the second high potential voltage GVDD1 to the Qh node nQh through the node to which the second high potential voltage GVDD1 is applied. The second high potential voltage GVDD1 may be supplied from the node to which the second high potential voltage GVDD1 is applied to the Qh node nQh. The third transistor T3 may include a gate electrode connected to the Q node nQ, a first electrode connected to the node to which the second high potential voltage GVDD1 is applied, and a second electrode connected to the Qh node nQh.

The second circuit unit 72 may include an inverter circuit for inverting a potential of the Q node nQ to apply the inverted potential to the Qb node nQb(n). The inverter circuit of the second circuit unit 72 may include a Qb node charging unit and a Qb node discharging unit.

The Qb node charging unit may include a 4A^{th} transistor and a 4B^{th} transistor T4A and T4B. The 4A^{th} transistor T4A may include a 4A1^{th} transistor T4A1 and a 4A2^{th} transistor T4A2. The 4A1^{th} transistor T4A1 and the 4A2^{th} transistor T4A2 may be connected in series to reduce a leakage current. The 4B^{th} transistor T4B may include a 4B^{th} transistor T4B1 and a 4B2^{th} transistor T4B2. The 4B1^{th} transistor T4B1 and the 4B2^{th} transistor T4B2 may be connected in series to reduce a leakage current.

The Qb node charging unit may switch a current path between the node to which the second high potential voltage GVDD1 is applied and the Qb node nQb(n) according to the voltage Qb(n−1) applied from the (n−1) Qb node nQb(n−1) from the (n−1)^{th} signal transmission unit ST(n−1).

The 4A^{th} transistor T4A may be turned on when a voltage at an I node nI is the gate-on voltage VGH to connect the node to which the second high potential voltage GVDD1 is applied to the Qb node nQb(n), thereby charging the Qb node nQb(n) to a high voltage higher than or equal to the gate-on voltage VGH. The 4A^{th} transistor T4A may include a gate electrode connected to the I node nI, a first electrode connected to the node to which the second high potential voltage GVDD1 is applied, and a second electrode connected to the Qb node nQb(n).

The 4A^{th} transistor T4A may include a 4A1^{th} transistor T4A1 and a 4A2^{th} transistor T4A2 connected in series. The 4A1^{th} transistor T4A1 and the 4A2^{th} transistor T4A2 may be connected in series to reduce a leakage current. The 4A1^{th} transistor T4A1 may include a gate electrode connected to the I node nI, a first electrode connected to the node to which the second high potential voltage GVDD1 is applied, and a second electrode connected to the Qb node nQb(n). The 4A2^{th} transistor T4A2 may include a gate electrode connected to the I node nI, a first electrode connected to the second electrode of the 4A1^{th} transistor T4A1, and a second electrode connected to the Qb node nQb(n).

The 4B^{th} transistor T4B may be turned on, when the voltage Qb(n−1) applied from the (n−1)^{th} Qb node nQb(n−1) of the (n−1)^{th} signal transmission unit ST(n−1) is a high voltage higher than or equal to the gate-on voltage VGH, to supply the second high potential voltage GVDD1 to the I node nI. The I node nI may be charged to the gate-on voltage VGH or higher. The 4B^{th} transistor T4B may include a gate electrode connected to the node to which the voltage Qb(n−1) applied from the (n−1)^{th} Qb node nQb(n−1) of the (n−1)^{th} signal transmission unit ST(n−1) is input, a first electrode connected to the node to which the second high potential voltage GVDD1 is applied, and a second electrode connected to the I node nI.

The 4B^{th} transistor T4B may include a 4B1^{th} transistor T4B1 and a 4B2^{th} transistor T4B2. The 4B1^{th} transistor T4B1 may include a gate electrode connected to the node to which the voltage Qb(n−1) applied from the (n−1)^{th} Qb node nQb(n−1) of the (n−1)^{th} signal transmission unit ST(n−1) is input, a first electrode connected to the node to which the second high potential voltage GVDD1 is applied, and a second electrode connected to the I node nI. The 4B2^{th} transistor T4B2 may include a gate electrode connected to the node to which the voltage Qb(n−1) applied from the (n−1)^{th} Qb node nQb(n−1) of the (n−1)^{th} signal transmission unit ST(n−1) is input, a first electrode connected to the second electrode of the 4B1^{th} transistor T4B1, and a second electrode connected to the I node nI.

The Qb node discharging unit may include a 5A^{th} transistor and a 5B^{th} transistor T5A and T5B. The 5A^{th} transistor and the 5B^{th} transistor T5A and T5B may be connected in series.

The Qb node discharging unit may be turned on, when the voltage at the Q node nQ and the voltage of the previous carry signal C(n−1) input from the (n−1)^{th} signal transmission unit ST(n−1) are a high voltage that is higher than or equal to the gate high voltage VGH, to discharge the Qb node nQb(n).

The 5A^{th} transistor T5A may be turned on, when the voltage at the Qh node nQh is a high voltage that is higher than or equal to the gate-on voltage VGH, to connect the I node nI to the Qb node nQb(n). The 5A^{th} transistor T5A may include a gate electrode connected to the Qh node nQh, a first electrode connected to the I node nI, and a second electrode connected to the Qb node nQb(n).

The 5B^{th} transistor T5B may be turned on, when the voltage at the Qh node nQh is a high voltage that is higher than or equal to the gate-on voltage VGH, to connect the Qb node nQb(n) to the second low potential voltage GVSS1. The voltage at the Qb node nQb(n) may be discharged to the second low potential voltage GVSS1. The 5B^{th} transistor T5B may include a gate electrode connected to the Qh node nQh, a first electrode connected to the Qb node nQb(n), and a second electrode connected to the node to which the second low potential voltage GVSS1 is applied.

The third circuit unit 73 may include a 3-1 circuit unit 731, a 3-2 circuit unit 732, and a 3-3 circuit unit 733.

The 3-1 and 3-2 circuit units 731 and 732 may output the gate signal GOUT(n) and the carry signal C(n) in response to the potentials of the Q node nQ and the Qb node nQb(n).

The 3-1 circuit unit 731 may include first buffer transistors T6 and T7 that output the carry signal C(n).

The first buffer transistors T6 and T7 may include the first pull-up transistor T6 turned on based on the potential of the Q node nQ and the first pull-down transistor T7 turned on based on the potential of the Qb node nQb(n). The first pull-up transistor T6 may be the sixth transistor T6. The first pull-down transistor T7 may be the seventh transistor T7.

The first pull-up transistor T6 may include a gate electrode connected to the Q node nQ, a first electrode connected to the node to which the second high potential voltage GVDD1 is applied, and a second electrode connected to a first output terminal O1 which outputs the carry signal C(n).

The first pull-down transistor T7 may include a gate electrode connected to the Qb node nQb(n), a first electrode connected to the node to which the second high potential voltage GVDD1 is applied, and a second electrode connected to the node to which the second low potential voltage GVSS1 is supplied.

The first buffer transistors T6 and T7 may output the carry signal C(n) based on the second high potential voltage GVDD1 applied through the node to which the second high potential voltage GVDD1 is applied and the second low potential voltage GVSS1 applied through the node to which the second low potential voltage GVSS1 is applied.

The 3-2 circuit unit 732 may include second buffer transistors T8 and T9 that output the gate signal GOUT(n).

The second buffer transistors T8 and T9 may include the second pull-up transistor T8 turned on based on the potential of the Q node nQ and the second pull-down transistor T9 turned on based on the potential of the Qb node nQb(n). The second pull-up transistor T8 may be the eighth transistor T8. The second pull-down transistor T9 may be the ninth transistor T9.

By using the tenth transistor T10, the first pull-up transistor T6 can be maintained at the gate-on voltage VGH, and the second pull-up transistor T8 can be maintained at the gate-off voltage VGL.

The second pull-up transistor T8 may include a gate electrode connected to one end of a fourth capacitor C4, a first electrode connected to the node to which the first high potential voltage GVDD0 is applied, and a second electrode connected to a second output terminal O2 which outputs the gate signal GOUT(n).

The second pull-down transistor T9 may include a gate electrode connected to the Qb node nQb(n), a first electrode connected to the second output terminal O2 which outputs the gate signal GOUT(n) and the other end of the fourth capacitor C4, and a second electrode connected to the node to which the first low potential voltage GVSS0 is applied.

The second buffer transistors T8 and T9 may output the gate signal GOUT(n) based on the first high potential voltage GVDD0 applied through the node to which the first high potential voltage GVDD0 is applied and the first low potential voltage GVSS0 applied through the node to which the first low potential voltage GVSS0 is applied.

The 3-3 circuit unit 733 may include a tenth transistor T10, an eleventh transistor T11, and a twelfth transistor T12. The 3-3 circuit unit 733 may stably control the switching of the input/output waveforms for the display time and the input/output waveforms for the sensing time for external compensation.

The tenth transistor T10 may be disposed between the sixth transistor T6 and the eighth transistor T8 to separate the Q node nQ that shares the gate electrodes of the sixth transistor T6 and the eighth transistor T8. The tenth transistor T10 may be disposed between the sixth transistor T6 and the eighth transistor T8 to separate electrical connection between the sixth transistor T6 and the eighth transistor T8 in response to a control signal CTRL(n). By arranging the tenth transistor T10, the sixth transistor T6 may be operated by the potential of the Q node nQ, and the eighth transistor T8 may be operated by the potential of a separate separated node. When the eleventh transistor T11 is turned on in a state in which the tenth transistor T10 is not present, the potential of the Q node nQ connected to the sixth transistor T6 and the eighth transistor T8 by the second low potential voltage GVSS1 may be the gate low voltage VGL. In this case, the carry signal C(n) output from the first output terminal O1 may be in a floating state. Therefore, the next signal transmission unit (e.g., ST(n+1)) may operate abnormally.

The tenth transistor T10 may include a gate electrode connected to a control signal input terminal CI to which the control signal CTRL(n) (CTRLO(n)/CTRLE(n)/CTRLO(n+1)/CTRLE(n+1)) is input, a first electrode connected to the Q node nQ, and a second electrode connected to the one end of the fourth capacitor C4 and the gate electrode of the second pull-up transistor T8.

The eleventh transistor T11 may be disposed between the sixth transistor T6 and the eighth transistor T8 to separate the Q node nQ that shares the gate electrodes of the sixth transistor T6 and the eighth transistor T8. The eleventh transistor T11 may serve to supply the second low potential voltage GVSS1 to the gate electrode of the eighth transistor T8 in response to a control bar signal CTRLB(n) to turn the eighth transistor T8 off. The eleventh transistor T11 may be disposed between the tenth transistor T10 and the eighth transistor T8 to supply the second low potential voltage GVSS1 to the eighth transistor T8. The eleventh transistor T11 may allow the eighth transistor T8 to be turned off, thereby preventing a short caused by simultaneously applying the first high potential voltage GVDD0 and the first low potential voltage GVSS0 to the second output terminal O2 in a state in which the twelfth transistor T12 has been turned on.

The eleventh transistor T11 may include a gate electrode connected to a control signal input terminal CBI1 to which the control bar signal CTRLB(n) (CTRLBO(n)/CTRLBE(n)/CTRLBO(n+1)/CTRLBE(n+1)) is input, a first electrode connected to the one end of the fourth capacitor C4 and the gate electrode of the second pull-up transistor T8, and a second electrode connected to the node to which the second low potential voltage GVSS0 is applied.

A problem in a case where both the tenth and eleventh transistors T10 and T11 are not present and only the twelfth transistor T12 is disposed will be described. The eighth transistor T8 may be turned on by the gate-on voltage VGH being applied to the Q node nQ. The gate signal GOUT(n) output from the second output terminal O2 may be the first high potential voltage GVDD0. Since both the tenth and eleventh transistors T10 and T11 are not present, the eighth transistor T8 may not be turned off, and in this state, when the twelfth transistor T12 is turned on, the first low potential voltage GVSS0 and the first high potential voltage GVDD0 may be simultaneously applied to the second output terminal O2, thereby causing a short. The tenth and eleventh transistors T10 and T11 may serve to separate the Q node nQ that shares the gate electrodes of the sixth and eighth transistors T6 and T8 to turn the eighth transistor T8 off. The tenth and eleventh transistors T10 and T11 may stably maintain the gate signal GOUT(n) output from the second output terminal O2 at the gate-off voltage VGL.

When the twelfth transistor T12 is not present in a state in which the Qb node nQb(n) is maintained at the gate low voltage VGL, even when the eighth transistor T8 is turned off by the tenth and eleventh transistors T10 and T11, the ninth transistor T9 may be turned off by the Qb node nQb(n) at the gate low voltage VGL. In this case, the gate signal GOUT(n) may be maintained at the gate-on voltage VGH by floating. The gate signal GOUT(n) may become an unknown state due to coupling to operate abnormally. The twelfth transistor T12 may serve to stably supply the first low potential voltage GVSS0 to the second output terminal O2 in response to the control bar signal CTRLB(n) in a state in which the eighth transistor T8 has been turned off. The twelfth transistor T12 may allow the gate signal GOUT(n) at the gate-off voltage VGL to be output from the second output terminal O2 in a state in which the eighth transistor T8 has been turned off.

The twelfth transistor T12 may include a gate electrode connected to a second control bar signal input terminal CBI2 to which the control bar signal CTRLB(n) (CTRLBO(n)/CTRLBE(n)/CTRLBO(n+1)/CTRLBE(n+1)) is input, a first electrode connected to the second output terminal O2 which outputs the gate signal GOUT(n) and the other end of the fourth capacitor C4, and a second electrode connected to the node to which the first low potential voltage GVSS0 is applied.

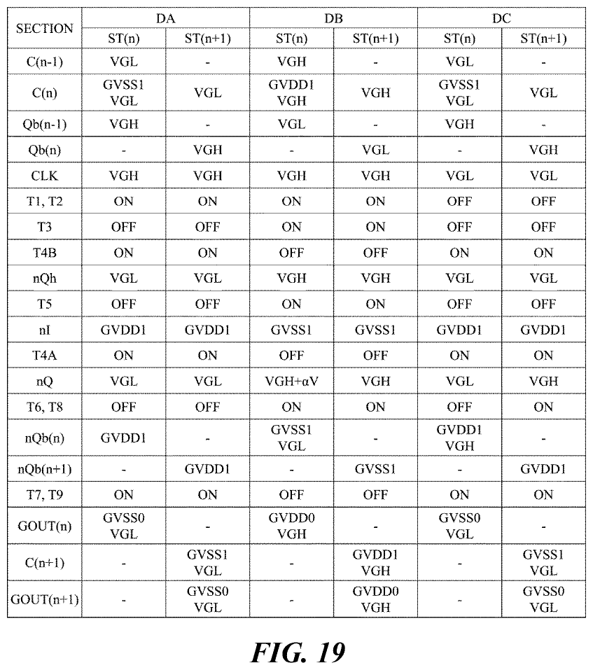

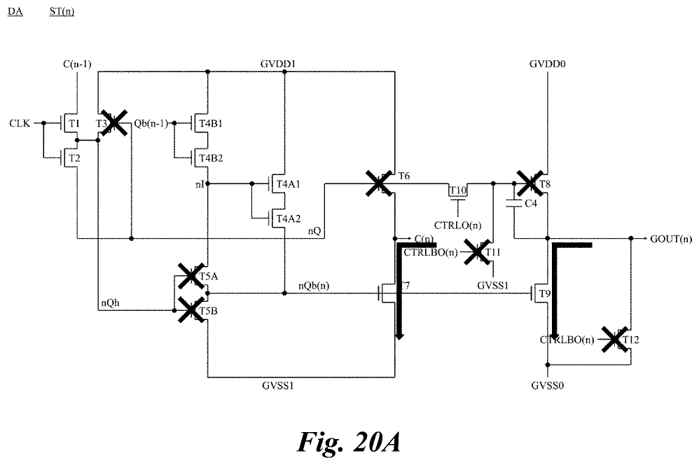

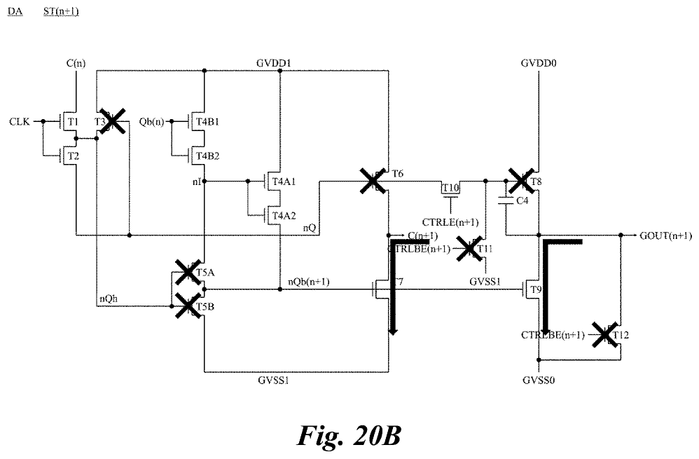

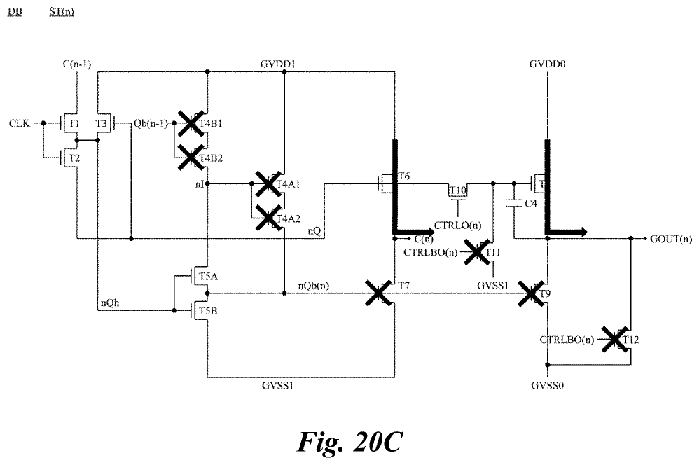

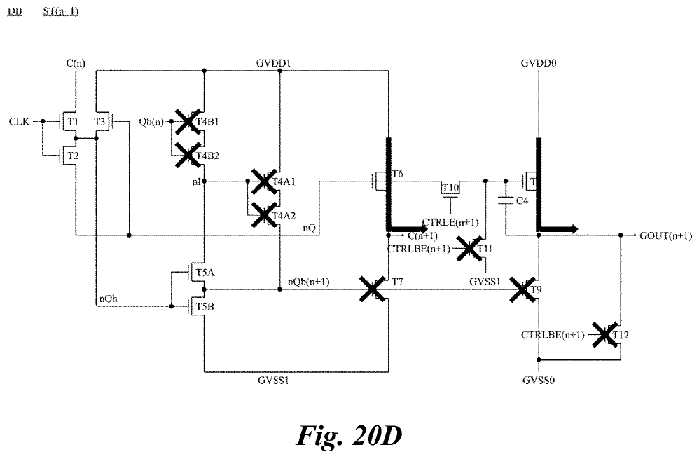

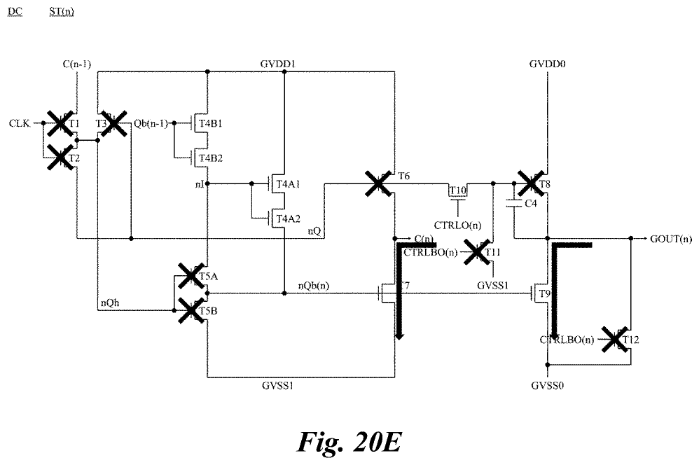

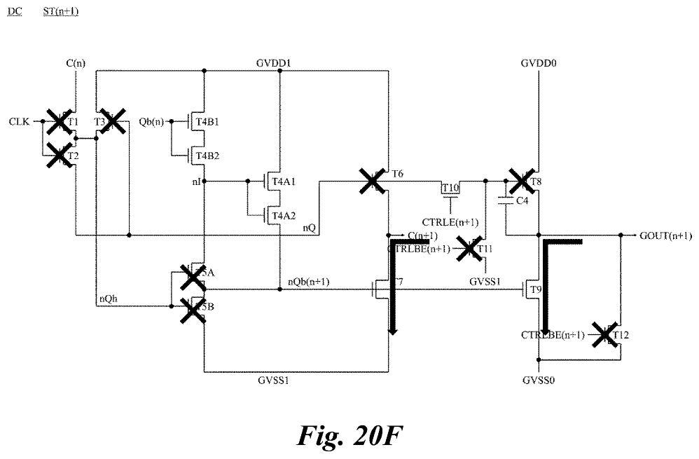

FIG. 19 is a view showing operating states of the signal transmission unit corresponding to DA to DC sections of FIG. 18. FIGS. 20A to 20F are circuit diagrams showing the operating states of the signal transmission unit corresponding to the DA section to the DC section of FIG. 18.

Although the following description will be made assuming that the n^{th} signal transmission unit ST(n) is an odd-numbered signal transmission unit and the (n+1) signal transmission unit ST(n+1) is an even-numbered signal transmission unit, the present disclosure is not limited thereto. When n is 1, C(n−1) may be the VST signal, and Qb(n−1) may be the QbST signal.

FIGS. 20A, 20C, and 20E show the operating state of the n^{th} signal transmission unit. The carry signal C(n−1) applied from the previous signal transmission unit, the Qb signal Qb(n−1) applied from the Qb node in the previous signal transmission unit, and the CLK signals CLK and CLK1 may be input to the n^{th} signal transmission unit ST(n). Both the odd-numbered control signal CTRLO and the odd-numbered control bar signal CTRLBO may be input to the n^{th} signal transmission unit ST(n).

FIGS. 20B, 20D, and 20F show the operating state of the (n+1)^{th} signal transmission unit. The carry signal C(n) applied from the previous signal transmission unit, the Qb signal Qb(n) applied from the Qb node in the previous signal transmission unit, and the CLK signals CLK and CLK2 may be input to the (n+1)^{th} signal transmission unit ST(n+1). Both the odd-numbered control signal CTRLE and the odd-numbered control bar signal CTRLBE may be input to the (n+1)^{th} signal transmission unit ST(n+1).

For the display time, the control signals CTRLO(n) and CTRLE(n+1) may be the gate-on voltages VGH. The tenth transistor T10 may be in the turned-on state.

For the display time, the control bar signals CTRLBO(n) and CTRLBE(n+1) may be the gate-off voltage VGL. The eleventh and twelfth transistors T11 and T12 may be in the turned-off state.

Referring to FIGS. 18, 19, and 20A, the carry signal C(n−1) input to the n^{th} signal transmission unit ST(n) in the DA section may be the gate-off voltage VGL, the Qb signal Qb(n−1) may be the gate-on voltage VGH, and the CLK signals CLK and CLK1 may be the gate-on voltage VGH.

The first and second transistors T1 and T2 may be in the turned-on state. The third transistor T3 may be in the turned-off state. The 4B^{th} transistors T4B1 and T4B2 may be in the turned-on state.

The potential of the Qh node nQh may be the gate-off voltage VGL. The fifth transistors T5A and T5B may be in the turned-off state.

The potential of the I node nI may be the second high potential voltage GVDD1. The 4A^{th} transistors T4A1 and T4A2 may be in the turned-on state.

The potential of the Q node nQ may be the gate-off voltage VGL. The sixth and eighth transistors T6 and T8 may be in the turned-off state.

The potential of the Qb node nQb(n) may be the second high potential voltage GVDD1. The seventh and ninth transistors T7 and T9 may be in the turned-on state.

The carry signal C(n) at the second low potential voltage GVSS1 may be output from the first output terminal. The carry signal C(n) at the gate-off voltage VGL may be output from the first output terminal.

The gate signal GOUT(n) at the first low potential voltage GVSS0 may be output from the second output terminal. The gate signal GOUT(n) at the gate-off voltage VGL may be output from the second output terminal.

Referring to FIGS. 18, 19, and 20B, the carry signal C(n) input to the (n+1)^{th} signal transmission unit ST(n+1) in the DA section may be the gate-off voltage VGL, the Qb signal Qb(n) may be the gate-on voltage VGH, and the CLK signals CLK and CLK2 may be the gate-on voltage VGH.

The first and second transistors T1 and T2 may be in the turned-on states. The third transistor T3 may be in the turned-off state. The 4B3 transistors T4B1 and T4B2 may be in the turned-on state.

The potential of the Qh node nQh may be the gate-off voltage VGL. The fifth transistors T5A and T5B may be in the turned-off state.

The potential of the I node nI may be the second high potential voltage GVDD1. The 4A^{th} transistors T4A1 and T4A2 may be in the turned-on state.

The potential of the Q node nQ may be the gate-off voltage VGL. The sixth and eighth transistors T6 and T8 may be in the turned-off state.

The potential of the Qb node nQb(n+1) may be the second high potential voltage GVDD1. The seventh and ninth transistors T7 and T9 may be in the turned-on state.

The carry signal C(n+1) at the second low potential voltage GVSS1 may be output from the first output terminal. The carry signal C(n+1) at the gate-off voltage VGL may be output from the first output terminal.

The gate signal GOUT(n+1) at the first low potential voltage GVSS0 may be output from the second output terminal. The gate signal GOUT(n+1) at the gate-off voltage VGL may be output from the second output terminal.

Referring to FIGS. 18, 19, and 20C, the carry signal C(n−1) input to the n^{th} signal transmission unit ST(n) in the DB section may be the gate-on voltage VGH, the Qb signal Qb(n−1) may be the gate-off voltage VGL, and the CLK signals CLK and CLK1 may be the gate-on voltage VGH.

The first and second transistors T1 and T2 may be in the turned-on state. The third transistor T3 may be in the turned-on state. The 4B3 transistors T4B1 and T4B2 may be in the turned-off state.

The potential of the Qh node nQh may be the gate-on voltage VGH. The fifth transistors T5A and T5B may be in the turned-on state.

The potential of the I node nI may be the second low potential voltage GVSS1. The 4A^{th} transistors T4A1 and T4A2 may be in the turned-off state.

The potential of the Q node nQ may be the gate-on voltage VGH. The potential of the Q node nQ may be the gate-on voltage VGH+αV. The sixth and eighth transistors T6 and T8 may be in the turned-on state.

The potential of the Qb node nQb(n) may be the second low potential voltage GVSS1. The potential of the Qb node nQb(n) may be the gate-off voltage VGL. The seventh and ninth transistors T7 and T9 may be in the turned-off state.

The carry signal C(n) at the second high potential voltage GVDD1 may be output from the first output terminal. The carry signal C(n) at the gate-on voltage VGH may be output from the first output terminal.

The gate signal GOUT(n) at the first high potential voltage GVDD0 may be output from the second output terminal. The gate signal GOUT(n) at the gate-on voltage VGH may be output from the second output terminal.

Referring to FIGS. 18, 19, and 20D, the carry signal C(n) input to the (n+1)^{th} signal transmission unit ST(n+1) in the DB section may be the gate-on voltage VGH, the Qb signal Qb(n) may be the gate-off voltage VGL, and the CLK signals CLK and CLK2 may be the gate-on voltage VGH.

The first and second transistors T1 and T2 may be in the turned-on state. The third transistor T3 may be in the turned-on state. The 4B3 transistors T4B1 and T4B2 may be in the turned-off state.

The potential of the Qh node nQh may be the gate-on voltage VGH. The fifth transistors T5A and T5B may be in the turned-on state.

The potential of the I node nI may be the second low potential voltage GVSS1. The 4A^{th} transistors T4A1 and T4A2 may be in the turned-off state.

The potential of the Q node nQ may be the gate-on voltage VGH. The sixth and eighth transistors T6 and T8 may be in the turned-on state.

The potential of the Qb node nQb(n+1) may be the second low potential voltage GVSS1. The seventh and ninth transistors T7 and T9 may be in the turned-off state.

The carry signal C(n+1) at the second high potential voltage GVDD1 may be output from the first output terminal. The carry signal C(n+1) at the gate-on voltage VGH may be output from the first output terminal.

The gate signal GOUT(n+1) at the first high potential voltage GVDD0 may be output from the second output terminal. The gate signal GOUT(n+1) at the gate-on voltage VGH may be output from the second output terminal.

Referring to FIGS. 18, 19, and 20E, the carry signal C(n−1) input to the n^{th} signal transmission unit ST(n) in the DC section may be the gate-off voltage VGL, the Qb signal Qb(n−1) may be the gate-on voltage VGH, and the CLK signals CLK and CLK1 may be the gate-on voltage VGH.

The first and second transistors T1 and T2 may be in the turned-on state. The third transistor T3 may be in the turned-off state. The 4B^{th} transistors T4B1 and T4B2 may be in the turned-on state.

The potential of the Qh node nQh may be the gate-off voltage VGL. The fifth transistors T5A and T5B may be in the turned-off state.

The potential of the I node nI may be the second high potential voltage GVDD1. The 4A^{th} transistors T4A1 and T4A2 may be in the turned-on state.

The potential of the Q node nQ may be the gate-off voltage VGL. The sixth and eighth transistors T6 and T8 may be in the turned-off state.

The potential of the Qb node nQb(n) may be the second high potential voltage GVDD1. The potential of the Qb node nQb(n) may be the gate-on voltage VGH. The seventh and ninth transistors T7 and T9 may be in the turned-on state.

The carry signal C(n) at the second low potential voltage GVSS1 may be output from the first output terminal. The carry signal C(n) at the gate-off voltage VGL may be output from the first output terminal.

The gate signal GOUT(n) at the first low potential voltage GVSS0 may be output from the second output terminal. The gate signal GOUT(n) at the gate-off voltage VGL may be output from the second output terminal.

Referring to FIGS. 18, 19, and 20F, the carry signal C(n) input to the (n+1)^{th} signal transmission unit ST(n+1) in the DC section may be the gate-off voltage VGL, the Qb signal Qb(n) may be the gate-on voltage VGH, and the CLK signals CLK and CLK2 may be the gate-off voltage VGL.

The first and second transistors T1 and T2 may be in the turned-off state. The third transistor T3 may be in the turned-off state. The 4B3 transistors T4B1 and T4B2 may be in the turned-on state.

The potential of the Qh node nQh may be the gate-off voltage VGL. The fifth transistors T5A and T5B may be in the turned-off state.

The potential of the I node nI may be the second high potential voltage GVDD1. The 4A^{th} transistors T4A1 and T4A2 may be in the turned-on state.

The potential of the Q node nQ may be the gate-on voltage VGH. The sixth and eighth transistors T6 and T8 may be in the turned-on state.

The potential of the Qb node nQb(n+1) may be the second high potential voltage GVDD1. The seventh and ninth transistors T7 and T9 may be in the turned-on state.

The carry signal C(n+1) at the second low potential voltage GVSS1 may be output from the first output terminal. The carry signal C(n+1) at the gate-off voltage VGL may be output from the first output terminal.

The gate signal GOUT(n+1) at the first low potential voltage GVSS0 may be output from the second output terminal. The gate signal GOUT(n+1) at the gate-off voltage VGL may be output from the second output terminal.

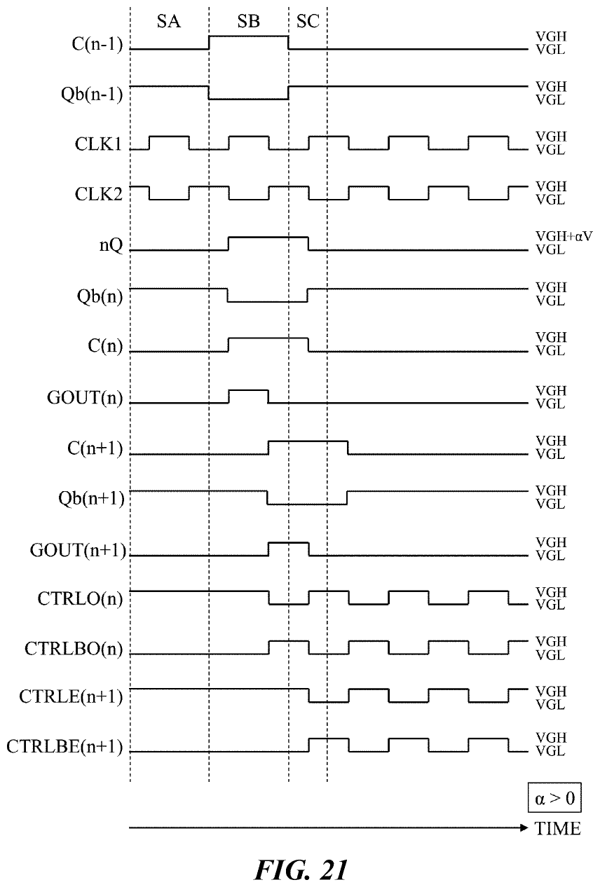

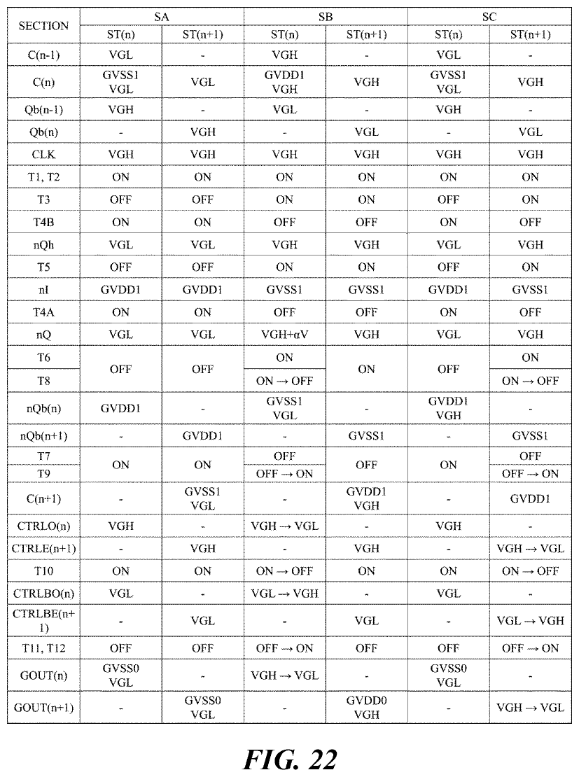

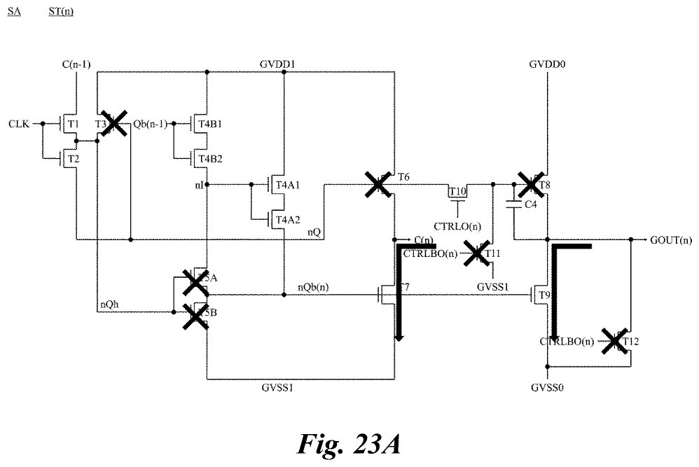

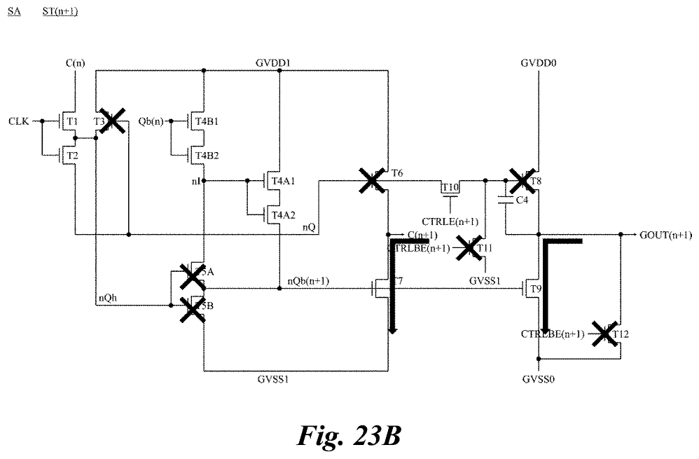

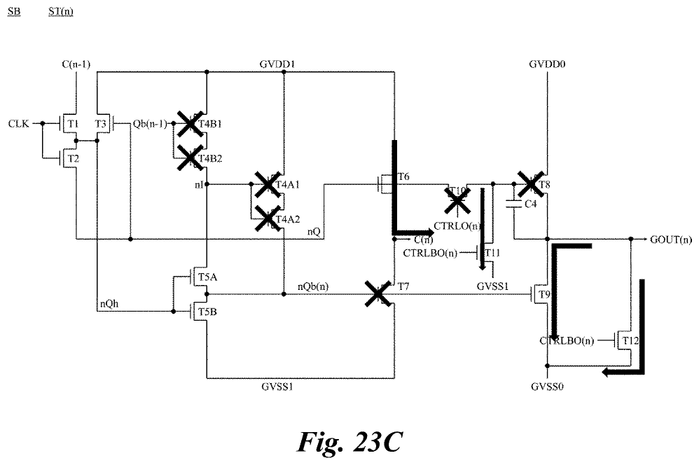

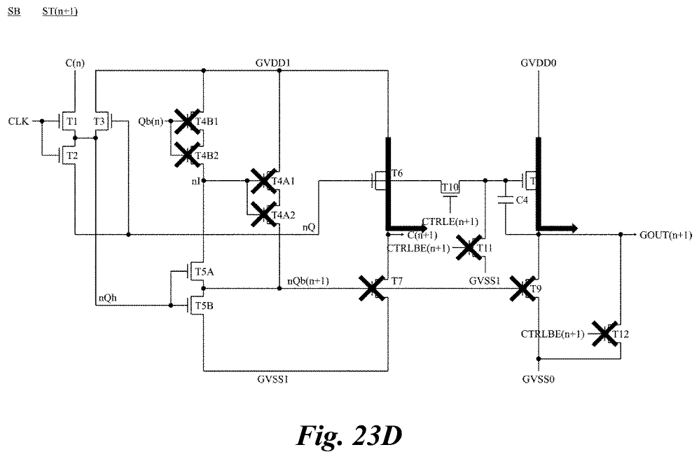

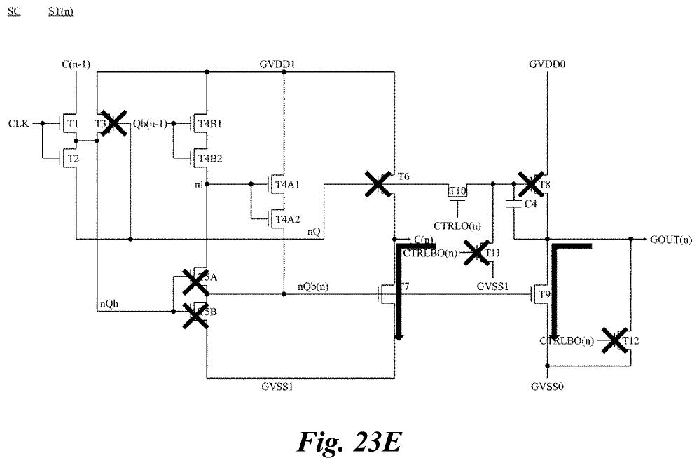

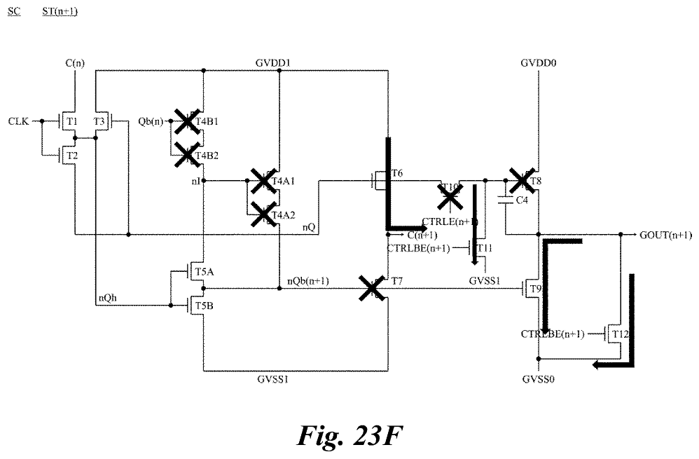

FIG. 21 is a waveform diagram showing input/output waveforms during the sensing time for external compensation in the gate driver according to one embodiment of the present specification. FIG. 22 is a view showing operating states of the signal transmission unit corresponding to SA to SC sections of FIG. 21. FIGS. 23A to 23F are circuit diagrams showing the operating states of the signal transmission unit corresponding to the SA section to the SC section of FIG. 21.

Although the following description will be made assuming that the n^{th} signal transmission unit ST(n) is an odd-numbered signal transmission unit and the (n+1) signal transmission unit ST(n+1) is an even-numbered signal transmission unit, the present disclosure is not limited thereto. When n is 1, C(n−1) may be the VST signal, and Qb(n−1) may be the QbST signal.

FIGS. 23A, 23C, and 23E show the operating state of the n^{th} signal transmission unit. The carry signal C(n−1) applied from the previous signal transmission unit, the Qb signal Qb(n−1) applied from the Qb node in the previous signal transmission unit, and the CLK signals CLK and CLK1 may be input to the n^{th} signal transmission unit ST(n). Both the odd-numbered control signal CTRLO and the odd-numbered control bar signal CTRLBO may be input to the n^{th} signal transmission unit ST(n).

FIGS. 23B, 23D, and 23F show the operating state of the (n+1)^{th} signal transmission unit. The carry signal C(n) applied from the previous signal transmission unit, the Qb signal Qb(n) applied from the Qb node in the previous signal transmission unit, and the CLK signals CLK and CLK2 may be input to the (n+1)^{th} signal transmission unit ST(n+1). Both the odd-numbered control signal CTRLE and the odd-numbered control bar signal CTRLBE may be input to the (n+1)^{th} signal transmission unit ST(n+1).

Referring to FIGS. 21, 22, and 23A, the carry signal C(n−1) input to the n^{th} signal transmission unit ST(n) in the SA section may be the gate-off voltage VGL, the Qb signal Qb(n−1) may be the gate-on voltage VGH, and the CLK signals CLK and CLK1 may be the gate-on voltage VGH.

The first and second transistors T1 and T2 may be in the turned-on state. The third transistor T3 may be in the turned-off state. The 4B^{th} transistors T4B1 and T4B2 may be in the turned-on state.

The potential of the Qh node nQh may be the gate-off voltage VGL. The fifth transistors T5A and T5B may be in the turned-off state.

The potential of the I node nI may be the second high potential voltage GVDD1. The 4A^{th} transistors T4A1 and T4A2 may be in the turned-on state.

The potential of the Q node nQ may be the gate-off voltage VGL. The sixth and eighth transistors T6 and T8 may be in the turned-off state.

The potential of the Qb node nQb(n) may be the second high potential voltage GVDD1. The seventh and ninth transistors T7 and T9 may be in the turned-on state.

The carry signal C(n) at the second low potential voltage GVSS1 may be output from the first output terminal. The carry signal C(n) at the gate-off voltage VGL may be output from the first output terminal.

The control signal CTRLO(n) input to the n^{th} signal transmission unit ST(n) may be maintained at the gate-on voltage VGH. The tenth transistor T10 may be in the turned-on state.

The control bar signal CTRLBO(n) may be the gate-off voltage VGL. The eleventh and twelfth transistors T11 and T12 may be in the turned-off state.

The gate signal GOUT(n) at the first low potential voltage GVSS0 may be output from the second output terminal. The gate signal GOUT(n) at the gate-off voltage VGL may be output from the second output terminal.

Referring to FIGS. 21, 22, and 23B, the carry signal C(n) input to the (n+1)^{th} signal transmission unit ST(n+1) in the SA section may be the gate-off voltage VGL, the Qb signal Qb(n) may be the gate-on voltage VGH, and the CLK signals CLK and CLK2 may be the gate-on voltage VGH.

The first and second transistors T1 and T2 may be in the turned-on state. The third transistor T3 may be in the turned-off state. The 4B^{th} transistors T4B1 and T4B2 may be in the turned-on state.

The potential of the Qh node nQh may be the gate-off voltage VGL. The fifth transistors T5A and T5B may be in the turned-off state.

The potential of the I node nI may be the second high potential voltage GVDD1. The 4A^{th} transistors T4A1 and T4A2 may be in the turned-on state.

The potential of the Q node nQ may be the gate-off voltage VGL. The sixth and eighth transistors T6 and T8 may be in the turned-off state.

The potential of the Qb node nQb(n+1) may be the second high potential voltage GVDD1. The seventh and ninth transistors T7 and T9 may be in the turned-on state.

The carry signal C(n+1) at the second low potential voltage GVSS1 may be output from the first output terminal. The carry signal C(n+1) at the gate-off voltage VGL may be output from the first output terminal.

The control signal CTRLO(n) input to the n^{th} signal transmission unit ST(n) may be maintained at the gate-on voltage VGH. The tenth transistor T10 may be in the turned-on state.

The control bar signal CTRLBO(n) may be the gate-off voltage VGL. The eleventh and twelfth transistors T11 and T12 may be in the turned-off state.

The gate signal GOUT(n+1) at the first low potential voltage GVSS0 may be output from the second output terminal. The gate signal GOUT(n+1) at the gate-off voltage VGL may be output from the second output terminal.

Referring to FIGS. 21, 22, and 23C, the carry signal C(n−1) input to the n^{th} signal transmission unit ST(n) in the SB section may be the gate-on voltage VGH, the Qb signal Qb(n−1) may be the gate-off voltage VGL, and the CLK signals CLK and CLK1 may be the gate-on voltage VGH.

The first and second transistors T1 and T2 may be in the turned-on state. The third transistor T3 may be in the turned-on state. The 4B3 transistors T4B1 and T4B2 may be in the turned-off state.

The potential of the Qh node nQh may be the gate-on voltage VGH. The fifth transistors T5A and T5B may be in the turned-on state.

The potential of the I node nI may be the second low potential voltage GVSS1. The 4A^{th} transistors T4A1 and T4A2 may be in the turned-off state.

The potential of the Q node nQ may be the gate-on voltage VGH+αV. The sixth transistor T6 may be in the turned-on state. The eighth transistor T8 may be initially in the turned-on state.

The potential of the Qb node nQb(n) may be the second low potential voltage GVSS1. The potential of the Qb node nQb(n) may be the gate-off voltage VGL. The seventh transistor T7 may be in the turned-off state. The ninth transistor T9 may be initially in the turned-off state.

The carry signal C(n) at the second high potential voltage GVDD1 may be output from the first output terminal. The carry signal C(n) at the gate-on voltage VGH may be output from the first output terminal.

The control signal CTRLO(n) input to the n^{th} signal transmission unit ST(n) may be initially the gate-on voltage VGH. A state of the control signal CTRLO(n) may be changed from the gate-on voltage VGH to the gate-off voltage VGL. The tenth transistor T10 may be initially in the turned-on state. The tenth transistor T10 may be changed from the turned-on state to the turned-off state.

The tenth transistor T10 may be disposed between the sixth transistor T6 and the eighth transistor T8 to separate the Q node nQ that shares the gate electrodes of the sixth transistor T6 and the eighth transistor T8. The tenth transistor T10 can prevent the next signal transmission unit (e.g., ST(n+1)) to abnormally operate because the carry signal C(n) output from the first output terminal becomes a floating state.

The control bar signal CTRLBO(n) may be initially the gate-off voltage VGL. A state of the control bar signal CTRLBO(n) may be changed from the initial gate-off voltage VGL to the gate-on voltage VGH. The state of the control bar signal CTRLBO(n) may be changed from the gate-off voltage VGL to the gate-on voltage VGH when the state of the control signal CTRLO(n) is changed from the gate-off voltage VGL to the gate-on voltage VGH. The eleventh and twelfth transistors T11 and T12 may be initially in the turned-off state. States of the eleventh and twelfth transistors T11 and T12 may be changed from the turned-off state to the turned-on state.

A state of the eighth transistor T8 may be changed from the turned-on state to the turned-off state. An ON-OFF relationship between the sixth transistor and the eighth transistor T8 may be inverted.

A state of the ninth transistor T9 may be changed from the turned-off state to the turned-on state.

The eleventh transistor T11 may serve to supply the second low potential voltage GVSS1 to the gate electrode of the eighth transistor T8 to turn the eighth transistor T8 off. The eleventh transistor T11 may turn the eighth transistor T8 off in response to the control bar signal CTRLB(n), thereby preventing a short caused by simultaneously applying the first high potential voltage GVDD0 and the first low potential voltage GVSS0 to the second output terminal in a state in which the twelfth transistor T12 has been turned on.

The twelfth transistor T12 may serve to stably supply the first low potential voltage GVSS0 to the second output terminal in a state in which the eighth transistor T8 has been turned off. The twelfth transistor T12 may allow the gate signal GOUT(n) at the gate-off voltage VGL to be output from the second output terminal in a state in which the eighth transistor T8 has been turned off.

The gate signal GOUT(n) at the gate-on voltage VGH may be output from the second output terminal. A state of the control signal GOUT(n) may be changed from the gate-on voltage VGH to the gate-off voltage VGL.

Referring to FIGS. 21, 22, and 23D, the carry signal C(n) input to the (n+1)^{th} signal transmission unit ST(n+1) in the DB section may be the gate-on voltage VGH, the Qb signal Qb(n) may be the gate-off voltage VGL, and the CLK signals CLK and CLK2 may be the gate-on voltage VGH.

The first and second transistors T1 and T2 may be in the turned-on state. The third transistor T3 may be in the turned-on state. The 4B^{th} transistors T4B1 and T4B2 may be in the turned-off state.

The potential of the Qh node nQh may be the gate-on voltage VGH. The fifth transistors T5A and T5B may be in the turned-on state.

The potential of the I node nI may be the second low potential voltage GVSS1. The 4A^{th} transistors T4A1 and T4A2 may be in the turned-off state.

The potential of the Q node nQ may be the gate-on voltage VGH. The sixth and eighth transistors T6 and T8 may be in the turned-on state.

The potential of the Qb node nQb(n+1) may be the second low potential voltage GVSS1. The seventh and ninth transistors T7 and T9 may be in the turned-off state.

The carry signal C(n+1) at the second high potential voltage GVDD1 may be output from the first output terminal. The carry signal C(n+1) at the gate-on voltage VGH may be output from the first output terminal.

The control signal CTRLE(n+1) input to the (n+1)^{th} signal transmission unit ST(n+1) may be the gate-on voltage VGH. The tenth transistor T10 may be in the turned-on state.

The control bar signal CTRLBE(n+1) may be the gate-off voltage VGL. The eleventh and twelfth transistors T11 and T12 may be in the turned-off state.

The gate signal GOUT(n+1) at the first high potential voltage GVDD0 may be output from the second output terminal. The gate signal GOUT(n+1) at the gate-on voltage VGH may be output from the second output terminal. When the state of the gate signal GOUT(n) output from the second output terminal is changed from the gate-on voltage VGH to the gate-off voltage VGL, the gate signal GOUT(n+1) at the gate-on voltage VGH may be output from the second output terminal.

Referring to FIGS. 21, 22, and 23E, the carry signal C(n−1) input to the n^{th} signal transmission unit ST(n) in the SC section may be the gate-off voltage VGL, the Qb signal Qb(n−1) may be the gate-on voltage VGH, and the CLK signals CLK and CLK1 may be the gate-on voltage VGH.

The first and second transistors T1 and T2 may be in the turned-on state. The third transistor T3 may be in the turned-off state. The 4B^{th} transistors T4B1 and T4B2 may be in the turned-on state.

The potential of the Qh node nQh may be the gate-off voltage VGL. The fifth transistors T5A and T5B may be in the turned-off state.

The potential of the I node nI may be the second high potential voltage GVDD1. The 4A^{th} transistors T4A1 and T4A2 may be in the turned-on state.

The potential of the Q node nQ may be the gate-off voltage VGL. The sixth and eighth transistors T6 and T8 may be in the turned-off state.

The potential of the Qb node nQb(n) may be the second high potential voltage GVDD1. The potential of the Qb node nQb(n) may be the gate-on voltage VGH. The seventh and ninth transistors T7 and T9 may be in the turned-on state.

The carry signal C(n) at the second low potential voltage GVSS1 may be output from the first output terminal. The carry signal C(n) at the gate-off voltage VGL may be output from the first output terminal.

The control signal CTRLO(n) input to the n^{th} signal transmission unit ST(n) may be maintained at the gate-on voltage VGH. The tenth transistor T10 may be in the turned-on state.

The control bar signal CTRLBO(n) may be the gate-off voltage VGL. The eleventh and twelfth transistors T11 and T12 may be in the turned-off state.

The gate signal GOUT(n) at the first low potential voltage GVSS0 may be output from the second output terminal. The gate signal GOUT(n) at the gate-off voltage VGL may be output from the second output terminal.

Referring to FIGS. 21, 22, and 23F, the carry signal C(n) input to the (n+1)^{th} signal transmission unit ST(n+1) in the DC section may be the gate-on voltage VGH, the Qb signal Qb(n) may be the gate-off voltage VGL, and the CLK signals CLK and CLK2 may be the gate-on voltage VGH.

The first and second transistors T1 and T2 may be in the turned-on state. The third transistor T3 may be in the turned-on state. The 4B^{th} transistors T4B1 and T4B2 may be in the turned-off state.

The potential of the Qh node nQh may be the gate-on voltage VGH. The fifth transistors T5A and T5B may be in the turned-on state.

The potential of the I node nI may be the second low potential voltage GVSS1. The 4A^{th} transistors T4A1 and T4A2 may be in the turned-off state.

The potential of the Q node nQ may be the gate-on voltage VGH. The sixth transistor T6 may be in the turned-on state. The eighth transistor T8 may be initially in the turned-on state.

The potential of the Qb node nQb(n+1) may be the second low potential voltage GVSS1. The seventh transistor T7 may be in the turned-off state. The ninth transistor T9 may be initially in the turned-off state.

The carry signal C(n+1) at the second low potential voltage GVSS1 may be output from the first output terminal. The carry signal C(n+1) at the gate-off voltage VGL may be output from the first output terminal.

The control signal CTRLE(n+1) input to the (n+1)^{th} signal transmission unit ST(n+1) may be initially the gate-on voltage VGH. A state of the control signal CTRLO(n) may be changed from the gate-on voltage VGH to the gate-off voltage VGL. The tenth transistor T10 may be initially in the turned-on state. The tenth transistor T10 may be changed from the turned-on state to the turned-off state.

The tenth transistor T10 may be disposed between the sixth transistor T6 and the eighth transistor T8 to separate the Q node nQ that shares the gate electrodes of the sixth transistor T6 and the eighth transistor T8. The tenth transistor T10 can prevent the next signal transmission unit (e.g., ST(n+1)) to abnormally operate because the carry signal C(n) output from the first output terminal becomes a floating state.

The control bar signal CTRLBO(n) may be initially the gate-off voltage VGL. A state of the control bar signal CTRLBO(n) may be changed from the initial gate-off voltage VGL to the gate-on voltage VGH. The state of the control bar signal CTRLBO(n) may be changed from the gate-off voltage VGL to the gate-on voltage VGH when the state of the control signal CTRLO(n) is changed from the gate-off voltage VGL to the gate-on voltage VGH. The eleventh and twelfth transistors T11 and T12 may be initially in the turned-off state. States of the eleventh and twelfth transistors T11 and T12 may be changed from the turned-off state to the turned-on state.

A state of the eighth transistor T8 may be changed from the turned-on state to the turned-off state. An ON-OFF relationship between the sixth transistor and the eighth transistor T8 may be inverted.

A state of the ninth transistor T9 may be changed from the turned-off state to the turned-on state.

The eleventh transistor T11 may serve to supply the second low potential voltage GVSS1 to the gate electrode of the eighth transistor T8 to turn the eighth transistor T8 off. The eleventh transistor T11 may turn the eighth transistor T8 off, thereby preventing a short caused by simultaneously applying the first high potential voltage GVDD0 and the first low potential voltage GVSS0 to the second output terminal in a state in which the twelfth transistor T12 has been turned on.

The twelfth transistor T12 may serve to stably supply the first low potential voltage GVSS0 to the second output terminal in a state in which the eighth transistor T8 has been turned off. The twelfth transistor T12 may allow the gate signal GOUT(n) at the gate-off voltage VGL to be output from the second output terminal in a state in which the eighth transistor T8 has been turned off.

The gate signal GOUT(n+1) at the gate-on voltage VGH may be initially output from the second output terminal. A state of the control signal GOUT(n+1) may be changed from the gate-on voltage VGH to the gate-off voltage VGL.

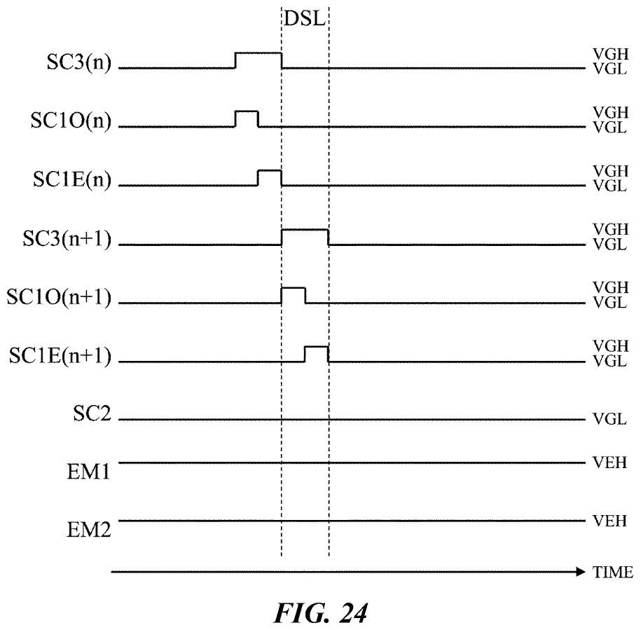

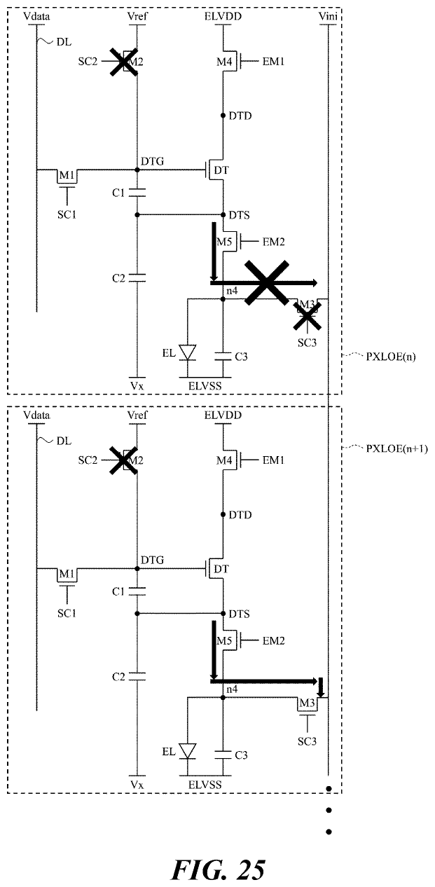

FIG. 24 is a waveform diagram showing voltage levels of signals input to switch elements shown in FIG. 13 during the sensing time for external compensation of the display device according to one embodiment of the present specification. FIG. 25 is a circuit diagram showing operating states of pixel circuits during the sensing time for external compensation of the display device according to one embodiment of the present specification.

Referring to FIGS. 24 and 25, for the threshold voltage (Vth) sensing time of the driving element DT for external compensation of the display device according to one embodiment of the present disclosure, the second switch element M2 to which the second scan pulse SC2 is applied may be turned off, and the fourth switch element M4 and the fifth switch element M5 to which the first EM pulse EM1 and the second EM pulse EM2 are applied may be turned on.

According to the present specification, in an DSL section, the third scan pulse SC3(n) applied to the n^{th} pixel line set PXLOE(n) may be maintained at the gate-off voltage VGL, and the third scan pulse SC3(n+1) applied to the (n+1)^{th} pixel line set PXLOE(n+1) may be maintained at the gate-on voltage VGH. The section in which the third scan pulse SC3(n) applied to the n^{th} pixel line set PXLOE(n) be maintained at the gate-on voltage VGH and the section in which the third scan pulse SC3(n+1) applied to the (n+1)^{th} pixel line set PXLOE(n+1) is maintained at the gate-on voltage VGH may not overlap each other. When the third scan pulse SC3(n) applied to the n^{th} pixel line set PXLOE(n) is maintained at the gate-on voltage VGH, the third scan pulse SC3(n+1) applied to the (n+1)^{th} pixel line set PXLOE(n+1) may be maintained at the gate-off voltage VGL, and when the third scan pulse SC3(n) applied to the n^{th} pixel line set PXLOE(n) is maintained at the gate-off voltage VGL, the third scan pulse SC3(n+1) applied to the (n+1)^{th} pixel line set PXLOE(n+1) may be maintained at the gate-on voltage VGH. When the third scan pulse SC3(n) applied to the n^{th} pixel line set PXLOE(n) is maintained at the gate-on voltage VGH, the third scan pulse SC3(n+1) applied to the (n+1)^{th} pixel line set PXLOE(n+1) may be maintained at the gate-off voltage VGL, and when the third scan pulse SC3(n+1) is maintained at the gate-on voltage VGH, the third scan pulse SC3(n) applied to the n^{th} pixel line set PXLOE(n) may be maintained at the gate-off voltage VGL. When the third scan pulse SC3(n) applied to the n^{th} pixel line set PXLOE(n) is maintained at the gate-off voltage VGL, the third scan pulse SC3(n+1) applied to the (n+1)^{th} pixel line set PXLOE(n+1) may be maintained at the gate-on voltage VGH, and when the third scan pulse SC3(n+1) is maintained at the gate-off voltage VGL, the third scan pulse SC3(n) applied to the n^{th} pixel line set PXLOE(n) may be maintained at the gate-on voltage VGH.

In the DSL section, at least a portion of the section in which the third scan pulse SC3(n) applied to the n^{th} pixel line set PXLOE(n) is maintained at the gate-on voltage VGH and then maintained at the gate-off voltage VGL may overlap the section in which the third scan pulse SC3(n+1) is maintained at the gate-on voltage VGH.

According to the present specification, while the third scan pulse SC3(n+1) at the gate-on voltage VGH is input to the (n+1)^{th} odd-numbered pixel line PXLO(n+1) and (n+1)^{th} even-numbered pixel line PXLE(n+1) included in the (n+1)^{th} pixel line set PXLOE(n+1), the third scan pulse SC3(n) at the gate-off voltage VGL may be applied to the n^{th} pixel line set PXLOE(n).

Therefore, it is possible to reduce a sensing load of the corresponding sensing line. For example, it is possible to reduce the capacitance of the sensing line and reduce the load. Therefore, it is possible to reduce the influence of the sensing time and noise, and sensing errors may less occur. In addition, it is possible to more quickly charge the capacitance than the related art at the same time upon sensing and enable more accurate sensing than the related art.

According to the present specification, it is possible to reduce a sensing load of a sensing line.

According to the present specification, it is possible to reduce a capacitance or capacitive load of the sensing line and reduce the load.

According to the present specification, it is possible to reduce the influence of the sensing time and noise, and sensing errors can less occur. In addition, by reducing a capacitive load upon sensing at the same time compared to the related art, it is possible to quickly charge the capacitance and enable more accurate sensing than the related art.

Although embodiments of the present disclosure have been described in more detail with reference to the accompanying drawings, the present disclosure is not necessarily limited to these embodiments, and various modifications may be carried out without departing from the technical spirit of the present disclosure.

Therefore, the embodiments disclosed in the present disclosure are not intended to limit the technical spirit of the present disclosure, and the scope of the technical spirit of the present disclosure is not limited by these embodiments.

Therefore, it should be understood that the above-described embodiments are illustrative and not restrictive in all respects.

The scope of the present disclosure should include those of the appended claims, and all technical spirits within the equivalent range should be construed as being included in the scope of the present disclosure.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A gate driver comprising a plurality of signal transmission units cascade-connected to one another and configured to receive a clock signal and sequentially output gate signals,
wherein at least one of the plurality of signal transmission units includes:
a first pull-up transistor connected to be turned on based on a potential of a Q node;
a second pull-up transistor connected to be turned on based on the potential of the Q node;
a first pull-down transistor connected to be turned on based on a potential of a Qb node;
a second pull-down transistor connected to be turned on based on the potential of the Qb node; and
an Ath transistor disposed between the first pull-up transistor and the second pull-up transistor and configured to electrically separate the Q node in response to a control signal.

2. The gate driver of claim 1, wherein the at least one of the plurality of signal transmission units further includes a Bth transistor disposed between the first pull-up transistor and the second pull-up transistor and configured to supply a second low potential voltage to the second pull-up transistor in response to a control bar signal.

3. The gate driver of claim 2, wherein the Bth transistor is disposed between the Ath transistor and the second pull-up transistor.

4. The gate driver of claim 3, further comprising:
a first output terminal configured to output a carry signal in response to operations of the first pull-up transistor and the first pull-down transistor;
a second output terminal configured to output the gate signal in response to operations of the second pull-up transistor and the second pull-down transistor; and
a Cth transistor connected to the second output terminal to supply a first low potential voltage in response to the control bar signal.

5. The gate driver of claim 4, wherein the control bar signal is a gate-off voltage when the control signal is a gate-on voltage, and
the control bar signal is a gate-on voltage when the control signal is a gate-off voltage.

6. The gate driver of claim 5, wherein a gate electrode of the Ath transistor is connected to a control signal input terminal configured to receive the control signal,
a first electrode of the Ath transistor is connected to the Q node, and
a second electrode of the Ath transistor is connected to a gate electrode of the second pull-up transistor.

7. The gate driver of claim 6, wherein a gate electrode of the Bth transistor is connected to a first control bar signal input terminal configured to receive the control bar signal,
a first electrode of the Bth transistor is connected to receive the second low potential voltage, and
a second electrode of the Bth transistor is connected to a gate electrode of the second pull-up transistor.

8. The gate driver of claim 7, wherein a gate electrode of the Cth transistor is connected to a second control bar signal input terminal configured to receive the control bar signal,
a first electrode of the Cth transistor is connected to receive the first low potential voltage, and
a second electrode of the Cth transistor is connected to the second output terminal.

9. The gate driver of claim 8, further comprising:
a first circuit unit configured to control charging or discharging of the Q node and the Qb node;
a second circuit unit including an inverter circuit configured to invert the potential of the Q node and apply the inverted potential to the Qb node; and
a third circuit unit including a 3-1 circuit unit including the first pull-up transistor and the first pull-down transistor, a 3-2 circuit unit including the second pull-up transistor and the second pull-down transistor, and a 3-3 circuit unit including the Ath transistor, the Bth transistor, and the Cth transistor.

10. The gate driver of claim 9, wherein the first circuit unit includes:
a first transistor including a gate electrode connected to receive the clock signal, a first electrode connected to receive the carry signal, and a second electrode connected to a Qh node;
a second transistor connected to the first transistor in series and including a gate electrode connected to receive the clock signal, a first electrode connected to the Qh node, and a second electrode connected to the Q node; and
a third transistor including a gate electrode connected to the Q node, a first electrode connected to receive a second high potential voltage, and a second electrode connected to the Qh node.

11. The gate driver of claim 9, wherein the second circuit unit includes:
a 4Ath transistor including a gate electrode connected to an I node, a first electrode connected to receive a second high potential voltage, and a second electrode connected to the Qb node;
a 4Bth transistor including a gate electrode connected to receive a Qb signal, a first electrode connected to receive the second high potential voltage, and a second electrode connected to the I node;
a 5Ath transistor including a gate electrode connected to a Qh node, a first electrode connected to the I node, and a second electrode connected to the Qb node; and
a 5Bth transistor including a gate electrode connected to the Qh node, a first electrode connected to the Qb node, and a second electrode connected to receive the second low potential voltage.

12. The gate driver of claim 11, wherein the 4Ath transistor includes:
a 4A1th transistor including a gate electrode connected to the I node, a first electrode connected to a node connected to receive the second high potential voltage, and a second electrode connected to the Qb node; and
a 4A2th transistor connected to the 4A1th transistor in series and including a gate electrode connected to the I node, a first electrode connected to a second electrode of the 4A1th transistor, and a second electrode connected to the Qb node, and
the 4Bth transistor includes:
a 4B1th transistor including a gate electrode connected to receive the Qb signal, a first electrode connected to receive the second high potential voltage, and a second electrode connected to the I node; and
a 4B2th transistor connected to the 4B1th transistor in series and including a gate electrode connected to receive the Qb signal, a first electrode connected to a second electrode of the 4B1th transistor, and a second electrode connected to the I node.

13. The gate driver of claim 5, wherein, when the control signal is changed from a gate-on voltage to a gate-off voltage, the control bar signal is changed from a gate-off voltage to a gate-on voltage.

14. The gate driver of claim 5, wherein, when the control signal is changed from a gate-on voltage to a gate-off voltage, an ON-OFF relationship between the first pull-up transistor and the second pull-up transistor is inverted.

15. The gate driver of claim 5, wherein, when the control signal is changed from a gate-on voltage to a gate-off voltage, a gate signal is changed from a gate-on voltage to a gate-off voltage.

16. A gate driver comprising an nth signal transmission unit and an (n+1)th signal transmission unit configured to receive a clock signal and sequentially output gate signals and cascade-connected to each other, n being a positive integer of 1 or more,
wherein each of the nth signal transmission unit and the (n+1)th signal transmission unit includes:
a first pull-up transistor configured to be turned on based on a potential of a Q node;
a second pull-up transistor configured to be turned on based on the potential of the Q node;
a first pull-down transistor configured to be turned on based on a potential of a Qb node;
a second pull-down transistor configured to be turned on based on the potential of the Qb node;
a first output terminal configured to output a carry signal in response to operations of the first pull-up transistor and the first pull-down transistor;
a second output terminal configured to output the gate signal in response to operations of the second pull-up transistor and the second pull-down transistor;
an Ath transistor disposed between the first pull-up transistor and the second pull-up transistor and configured to electrically separate the Q node in response to a control signal;
a Bth transistor disposed between the Ath transistor and the second pull-up transistor and configured to supply a second low potential voltage to the second pull-up transistor in response to a control bar signal; and
a Cth transistor connected to the second output terminal to supply a first low potential voltage in response to the control bar signal.

17. The gate driver of claim 16, wherein, when a gate signal output from the (n+1)th signal transmission unit is changed from a gate-off voltage to a gate-on voltage, a gate signal output from the nth signal transmission unit is changed from the gate-on voltage to the gate-off voltage.

18. A display device comprising:
a gate driver including an nth signal transmission unit and an (n+1)th signal transmission unit that are cascade-connected to each other, n being a positive integer of 1 or more;
an nth pixel line set including an nth odd-numbered pixel line that receives an nth gate signal output from the nth signal transmission unit and an nth even-numbered pixel line that receives the nth gate signal output from the nth signal transmission unit; and
an (n+1)th pixel line set including an (n+1)th odd-numbered pixel line that receives an (n+1)th gate signal output from the (n+1)th signal transmission unit and an (n+1)th even-numbered pixel line that receives an (n+1)th gate signal output from the (n+1)^{th} signal transmission unit,
wherein, for a sensing time for external compensation, when the nth gate signal is a gate-on voltage, the (n+1)th gate signal is a gate-off voltage, and when the (n+1)th gate signal is a gate-on voltage, the nth gate signal is a gate-off voltage.

19. The display device of claim 18, wherein, for the sensing time for external compensation, when the nth gate signal is a gate-off voltage, the (n+1)th gate signal is a gate-on voltage, and when the (n+1)th gate signal is a gate-off voltage, the nth gate signal is a gate-on voltage.

20. The display device of claim 19, wherein each pixel circuit included in the nth pixel line set and the (n+1)th pixel line set includes a third switch element including a gate electrode configured to receive the nth gate signal or the (n+1)th gate signal, a first electrode connected to a fourth node connected to an anode of a light emitting element, and a second electrode configured to receive a sensing voltage.
